(19) United States
(12) Patent Application Publication
(10) Pub. No.: US 2024/0144196 A1
(43) Pub. Date: May 2, 2024

(54) TIME/DATE ADJUSTMENT APPARATUS, TIME/DATE ADJUSTMENT METHOD, AND PROGRAM

(71) Applicant: E4 Inc., Tokyo (JP)

(72) Inventor: Taichiro SUGIMOTO, Tokyo (JP)

(21) Appl. No.: 18/548,573

(22) PCT Filed: Feb. 22, 2022
(86) PCT No.: PCT/JP2022/007296

§ 371 Date: Sep. 1, 2023

(30) Foreign Application Priority Data
Mar. 3, 2021 (JP) 2021-033069

(51) Int. Cl. G06Q 10/1093

(52) U.S. Cl. CPC G06Q 10/1095

(57) ABSTRACT

A time/date adjustment apparatus sets an adjustment condition including designation of a participant, refers to schedule information of the participant, extracts available time/dates of the participant satisfying the adjustment condition as first candidate time/dates, determines second candidate time/dates obtained by editing the extracted first candidate time/dates and registers the second candidate time/dates in a storage unit, issues access information for a time/date adjustment screen, refers to the schedule information of the participant when a second terminal apparatus used by an adjustment partner performs access based on the access information, extracts third candidate time/dates that are available time/dates of the participant satisfying the adjustment condition and are within a range of the second candidate time/dates registered in the storage unit, causes the second terminal apparatus to display the time/date adjustment screen presenting the extracted third candidate time/dates, determines an assembly time/date out of the third candidate time/dates.

### TECHNICAL FIELD

The present invention relates to a time/date adjustment apparatus, a time/date adjustment method, and a program. The present invention claims priority based on Japanese Patent Application No. 2021-033069 filed on Mar. 3, 2021, the contents of which are incorporated herein by reference for designated states where incorporation of literature by reference is permitted.

### BACKGROUND ART

Conventionally, adjustment of a time/date (time and date) of an assembly in business requires a large number of steps such as checking of a schedule of each participant and securing a site, and is therefore considerably bothersome work taking time and efforts.

Note that, regarding checking of schedules of participants, it is considered that a calendar tool is referred to, as many businesspersons manage their plans using a calendar tool provided on the Internet in recent years.

Regarding the calendar tool, for example, PTL 1 provides the following description: “a schedule information sharing method including the steps of: performing membership application registration by each of a plurality of applicants and a plurality of users, the plurality of applicants applying for distribution of schedule information, the plurality of users using the schedule information of the distribution, the plurality of applicants and the plurality of users each being a member of a system that distributes and shares the schedule information via the Internet; executing by a scheduler performing schedule management below; disclosing and distributing, by the applicant, the schedule information to the user; registering, by the user, a target desiring distribution of the disclosed schedule information; and based on a registered desired distribution target of the user, synchronizing and presetting the schedule information related thereto to a calendar of all of user terminals.”

### CITATION LIST

### Patent Literature

PTL 1: JP 2019-219831 A

### SUMMARY OF INVENTION

### Technical Problem

In a technique described in PTL 1, a plurality of users being members of a system can share schedule information with each other, and use the schedule information for adjustment of a time/date of an assembly. However, even if the system is used, schedules of participants in a meeting or the like may be updated and changed from moment to moment. When a non-member of the system is included in the participants in the assembly, a schedule of the non-member needs to be individually checked, which makes it difficult to perform adjustment of a time/date of the assembly without causing an overlap between existing plans of each of the participants and time at which the assembly is held, in other words, without causing a double booking.

The present invention is made in view of such circumstances as described above, and has an object to allow adjustment of a time/date of an assembly to be easily performed without causing a double booking.

### Solution to Problem

The present application includes a plurality of solutions to at least a part of the problems described above, examples of which are described as follows.

In order to solve the problems described above, a time/date adjustment apparatus according to one aspect of the present invention includes: an adjustment condition setting unit configured to set an adjustment condition related to an assembly; and a time/date adjustment unit configured to adjust an assembly time/date based on the adjustment condition. The adjustment condition setting unit causes a first terminal apparatus used by an adjustment initiator to display a condition setting screen for setting the adjustment condition, and sets the adjustment condition including designation of a participant, based on an input of the adjustment initiator on the condition setting screen. The time/date adjustment unit refers to schedule information of the participant managed by an external system, and extracts available time/dates of the participant satisfying the adjustment condition as first candidate time/dates. The time/date adjustment unit causes the first terminal apparatus to display a time/date editing screen for editing the extracted first candidate time/dates, and determines second candidate time/dates edited, based on the input of the adjustment initiator on the time/date editing screen and registers the second candidate time/dates in a storage unit. The time/date adjustment unit issues access information for a time/date adjustment screen. When a second terminal apparatus used by an adjustment partner performs access based on the access information, the time/date adjustment unit refers to the schedule information of the participant, and extracts third candidate time/dates that are available time/dates of the participant satisfying the adjustment condition and are within a range of the second candidate time/dates registered in the storage unit. The time/date adjustment unit causes the second terminal apparatus to display the time/date adjustment screen presenting the extracted third candidate time/dates, and determines an assembly time/date out of the third candidate time/dates, based on a selection operation of the adjustment partner on the time/date adjustment screen. The time/date adjustment unit registers the determined assembly time/date in the schedule information of the participant managed by the external system.

The adjustment condition setting unit can cause the first terminal apparatus to display a condition initial value setting screen for setting an initial value of the adjustment condition for each type of the assembly, and cause the storage unit to store an adjustment condition initial value set by the adjustment initiator on the condition initial value setting screen. The adjustment condition setting unit can cause the first terminal apparatus to display the condition setting screen reflecting the adjustment condition initial value stored in the storage unit, based on an operation of the adjustment initiator of selecting the type of the assembly.

The participant can be the adjustment initiator themselves, or a belonging member of an organization to which the adjustment initiator belongs other than the adjustment initiator.

When a plurality of the participants are designated as the adjustment condition, the time/date adjustment unit can refer to the schedule information of all of the plurality of the participants managed by the external system, and extract the available time/dates common to all of the plurality of the participants satisfying the adjustment condition as the first candidate time/dates, and when the second terminal apparatus used by the adjustment partner performs access based on the access information, the time/date adjustment unit can refer to the schedule information of all of the plurality of the participants, and extract the third candidate time/dates that are the available time/dates common to all of the plurality of the participants satisfying the adjustment condition and are within the range of the second candidate time/dates registered in the storage unit.

When a plurality of the participants are designated as the adjustment condition, the time/date adjustment unit can refer to the schedule information of all of the plurality of the participants managed by the external system, and extract the available time/dates of at least one of all of the plurality of the participants satisfying the adjustment condition as the first candidate time/dates, and when the second terminal apparatus used by the adjustment partner performs access based on the access information, the time/date adjustment unit can refer to the schedule information of all of the plurality of the participants, and extract the third candidate time/dates that are the available time/dates of at least one of all of the plurality of the participants satisfying the adjustment condition and are within the range of the second candidate time/dates registered in the storage unit.

The adjustment condition can include information for designating a site to be used for the assembly. The time/date adjustment unit can refer to schedule information of the designated site in addition to the schedule information of the participant managed by the external system, and extract the available time/dates of both of the participant and the site satisfying the adjustment condition as the first candidate time/dates. When the second terminal apparatus performs access based on the access information, the time/date adjustment unit can refer to the schedule information of the participant and the site, and extract the third candidate time/dates that are the available time/dates of both of the participant and the site satisfying the adjustment condition and are within the range of the second candidate time/dates registered in the storage unit.

The adjustment condition can include information for designating a plurality of sites that is allowed to be used for the assembly. The time/date adjustment unit can refer to schedule information of the plurality of designated sites in addition to the schedule information of the participant managed by the external system, and extract the available time/dates of both of the participant and one of the plurality of designated sites satisfying the adjustment condition as the first candidate time/dates. When the second terminal apparatus performs access based on the access information, the time/date adjustment unit can refer to the schedule information of the participant and the plurality of sites, and extract the third candidate time/dates that are the available time/dates of both of the participant and one of the plurality of designated sites satisfying the adjustment condition and are within the range of the second candidate time/dates registered in the storage unit.

The adjustment condition setting unit can receive designation of a place of the assembly, based on the input of the adjustment initiator on the condition setting screen. The time/date adjustment unit can cause the second terminal apparatus performing access based on the access information to display the time/date adjustment screen displaying the place of the assembly designated by the adjustment initiator.

On the time/date adjustment screen displayed in the second terminal apparatus, the adjustment partner is allowed to change the place of the assembly designated by the adjustment initiator. The time/date adjustment unit can cause results of the change of the place of the assembly by the adjustment partner to reflect in the schedule information of the participant managed by the external system.

The adjustment condition setting unit can receive designation of a method of the assembly, based on the input of the adjustment initiator on the condition setting screen. The time/date adjustment unit can cause the second terminal apparatus performing access based on the access information to display the time/date adjustment screen displaying the method of the assembly designated by the adjustment initiator.

On the time/date adjustment screen displayed in the second terminal apparatus, the adjustment partner is allowed to change the method of the assembly designated by the adjustment initiator. The time/date adjustment unit can cause results of the change of the method of the assembly by the adjustment partner to reflect in the schedule information of the participant managed by the external system.

The time/date adjustment apparatus can further include an authentication unit configured to perform authentication processing of the adjustment initiator with the external system. The time/date adjustment unit can refer to the schedule information of the participant being a belonging member of an organization to which the adjustment initiator belongs, the schedule information requiring authentication, the schedule information being managed by the external system.

The adjustment condition can include information for designating time required for the assembly, a time frame in which the assembly is capable of being held, and information for designating an extraction span. The time/date adjustment unit can extract a time/date in which the time required is capable of being secured in the time frame in which the assembly is capable of being held out of the available time/dates of the participant in the extraction span.

The adjustment condition can include information for designating time secured before and after the assembly. The time/date adjustment unit can extract a time/date in which the time required is capable of being secured in the time frame in which the assembly is capable of being held and the time/date in which the time secured before and after is capable of being secured out of the available time/dates of the participant in the extraction span.

The time/date adjustment unit can cause the first terminal apparatus to display the time/date editing screen presenting the extracted first candidate time/dates and an existing plan of the participant.

A time/date adjustment method according to another aspect of the present invention is a time/date adjustment method performed by a time/date adjustment apparatus. The time/date adjustment method includes: an adjustment condition setting step of setting an adjustment condition related to an assembly; and a time/date adjustment step of adjusting an assembly time/date based on the adjustment condition. The adjustment condition setting step includes causing a first terminal apparatus used by an adjustment initiator to display a condition setting screen for setting the adjustment condition, and setting the adjustment condition including designation of a participant, based on an input of the adjustment initiator on the condition setting screen. The time/date adjustment step includes referring to schedule information of the participant managed by an external system, and extracting available time/dates of the participant satisfying the adjustment condition as first candidate time/dates. The time/date adjustment step includes causing the first terminal apparatus to display a time/date editing screen for editing the extracted first candidate time/dates, and determining second candidate time/dates edited, based on the input of the adjustment initiator on the time/date editing screen and registering the second candidate time/dates in a storage unit. The time/date adjustment step includes issuing access information for a time/date adjustment screen. When a second terminal apparatus used by an adjustment partner performs access based on the access information, the time/date adjustment step includes referring to the schedule information of the participant, and extracting third candidate time/dates that are available time/dates of the participant satisfying the adjustment condition and are within a range of the second candidate time/dates registered in the storage unit. The time/date adjustment step includes causing the second terminal apparatus to display the time/date adjustment screen presenting the extracted third candidate time/dates, and determining an assembly time/date out of the third candidate time/dates, based on a selection operation of the adjustment partner on the time/date adjustment screen. The time/date adjustment step includes registering the determined assembly time/date in the schedule information of the participant managed by the external system.

A program according to yet another aspect of the present invention is configured to cause a computer to function as: an adjustment condition setting unit configured to set an adjustment condition related to an assembly; and a time/date adjustment unit configured to adjust an assembly time/date based on the adjustment condition. The adjustment condition setting unit causes a first terminal apparatus used by an adjustment initiator to display a condition setting screen for setting the adjustment condition, and sets the adjustment condition including designation of a participant, based on an input of the adjustment initiator on the condition setting screen. The time/date adjustment unit refers to schedule information of the participant managed by an external system, and extracts available time/dates of the participant satisfying the adjustment condition as first candidate time/dates. The time/date adjustment unit causes the first terminal apparatus to display a time/date editing screen for editing the extracted first candidate time/dates, and determines second candidate time/dates edited, based on the input of the adjustment initiator on the time/date editing screen and registers the second candidate time/dates in a storage unit. The time/date adjustment unit issues access information for a time/date adjustment screen. When a second terminal apparatus used by an adjustment partner performs access based on the access information, the time/date adjustment unit refers to the schedule information of the participant, and extracts third candidate time/dates that are available time/dates of the participant satisfying the adjustment condition and are within a range of the second candidate time/dates registered in the storage unit. The time/date adjustment unit causes the second terminal apparatus to display the time/date adjustment screen presenting the extracted third candidate time/dates, and determines an assembly time/date out of the third candidate time/dates, based on a selection operation of the adjustment partner on the time/date adjustment screen. The time/date adjustment unit registers the determined assembly time/date in the schedule information of the participant managed by the external system.

### Advantageous Effects of Invention

According to the present invention, adjustment of a time/date of an assembly can be easily performed without causing a double booking.

Problems, configurations, and effects other than those described above will become apparent in the following description of embodiments.

### BRIEF DESCRIPTION OF DRAWINGS

FIG. 1 is a diagram illustrating a configuration example of a time/date adjustment system according to one embodiment of the present invention.

FIG. 2 is a diagram illustrating an example of each of member information, user information, and time/date adjustment information.

FIG. 3 is a sequence diagram for illustrating an example of time/date adjustment processing performed by the time/date adjustment system.

FIG. 4 is a diagram illustrating a display example of a condition setting screen.

FIG. 5 is a diagram illustrating a display example of the condition setting screen.

FIG. 6 is a diagram illustrating a display example of a time/date editing screen.

FIG. 7 is a diagram illustrating a display example of the time/date editing screen.

FIG. 8 is a diagram illustrating a display example of a time/date adjustment screen.

FIG. 9 is a diagram illustrating a display example of the time/date adjustment screen.

FIG. 10 is a diagram illustrating a display example of the time/date adjustment screen.

FIG. 11 is a diagram illustrating a display example of a confirmation screen.

FIG. 12 is a diagram illustrating a display example of a notification screen.

FIG. 13 is a diagram illustrating a display example of an initial value setting screen.

FIG. 14 is a diagram illustrating a display example of the initial value setting screen.

FIG. 15 is a sequence diagram for illustrating a first modification of the time/date adjustment processing performed by the time/date adjustment system.

FIG. 16 is a diagram illustrating a display example of an assembly type selection screen.

FIG. 17 is a sequence diagram for illustrating a second modification of the time/date adjustment processing performed by the time/date adjustment system.

### DESCRIPTION OF EMBODIMENTS

One embodiment according to the present invention will be described below with reference to the drawings. Note that, in all the drawings for describing one embodiment, the same members are denoted by the same reference signs in principle, and repeated description thereof will be omitted. It goes without saying that, in the following embodiment, constituent elements (including element steps and the like) thereof are not necessarily essential, except for a case in which there is particular and explicit description, a case in which it is considered that those are obviously essential in principle, and the like. Concerning descriptions “to consist of A”, “to be composed of A”, “to have A”, and “to include A”, it goes without saying that, except for a case in which there is particular and explicit description that only the element is provided, and the like, elements other than the element are not to be excluded. Similarly, in the following embodiment, when there is a reference to a shape, a positional relationship, and the like of a constituent element and the like, a shape and the like that are substantially close to or similar to those shape and the like are included, except for a case in which there is particular and explicit description, a case in which it is considered that those are not obviously true in principle, and the like.

<Time/Date Adjustment System 10 according to One Embodiment of Present Invention>

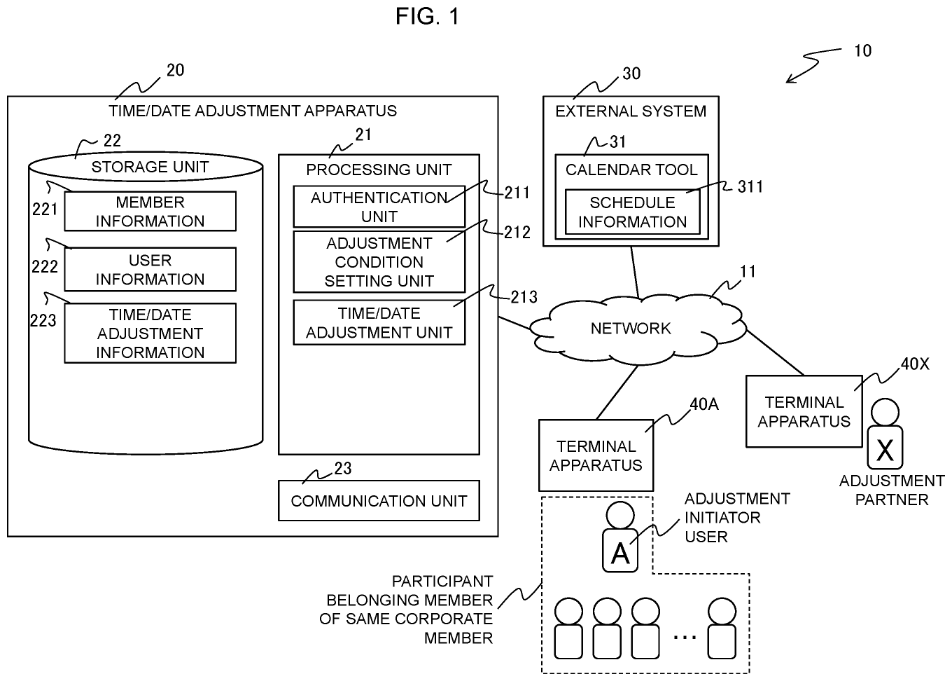

FIG. 1 illustrates a configuration example of a time/date adjustment system 10 according to one embodiment of the present invention.

The time/date adjustment system 10 is for assisting adjustment of a time/date of an assembly. The time/date adjustment system 10 includes a time/date adjustment apparatus 20, an external system 30, and terminal apparatuses 40A and 40X, which are connected via a network 11.

The network 11 is a two-way communication network, as typified by the Internet, a mobile phone communication network, and the like.

The time/date adjustment apparatus 20 performs adjustment of a time/date of an assembly with an adjustment partner X, in response to a request from an adjustment initiator A. Note that, as persons to participate in an assembly, the adjustment initiator A, a belonging member of an organization (a corporate member to be described below) such as a company to which the adjustment initiator A belongs, and an adjustment partner X are assumed. Note that, in this specification, among the persons to participate in the assembly described above, the adjustment initiator A and the belonging member of the organization to which the adjustment initiator A belongs are defined as “participants” of the assembly, and the adjustment partner X to participate in the assembly is not included in the “participants” (not referred to as a “participant”).

The external system 30 refers to a system that widely provides a calendar tool 31 as a web application for general consumers, corporations, and the like with or without a charge. As the calendar tool 31, for example, Google Calendar (trademark) and Microsoft Outlook (trademark) can be employed. The calendar tool 31 stores schedule information 311, in which action plans of a user of the calendar tool 31 and a booking status of assembly sites available to the user are registered.

The terminal apparatus 40A used by the adjustment initiator A includes a general computer, such as a personal computer and a smartphone, that can connect to the time/date adjustment apparatus 20 via the network 11. Similarly, the terminal apparatus 40X used by the adjustment partner X includes a general computer. The terminal apparatus 40A corresponds to a first terminal apparatus of the present invention, and the terminal apparatus 40X corresponds to a second terminal apparatus of the present invention.

Note that, in the present embodiment, the adjustment partner X to participate in an assembly operates the terminal apparatus 40X; however, in actuality, a representative (a secretary or the like) of the adjustment partner X may operate the terminal apparatus 40X. The adjustment initiator A may select a plurality of participants out of the belonging members of the same organization (corporate member to be described below) as the adjustment initiator A, and the adjustment initiator A may perform adjustment of a time/date on behalf of the plurality of participants.

Moreover, in FIG. 1, only the adjustment partner X is illustrated as an adjustment partner to participate in a meeting; however, there may be a plurality of adjustment partners.

The adjustment initiator A is an employee of a company that has conducted use registration with the time/date adjustment apparatus 20. The company or the like that has conducted use registration with the time/date adjustment apparatus 20 is hereinafter referred to as a corporate member. Among belonging members belonging to the corporate member (company or the like), a belonging member having a user account of the time/date adjustment apparatus 20 is defined as a user. It is essential that the adjustment initiator A be a user. Thus, the adjustment initiator A is hereinafter also referred to as a user A. A belonging member belonging to the same corporate member as the adjustment initiator A other than the adjustment initiator A may be a user, but this is not essential. Note that an individual, not a company or the like, can also conduct use registration with the time/date adjustment apparatus 20, and in that case, the individual who has conducted use registration is referred to as an individual member, and the individual member and the user can be regarded as the same.

Belonging members belonging to the corporate member of the time/date adjustment apparatus 20 manage their plans, using the calendar tool 31 provided by the external system 30. The corporate member of the time/date adjustment apparatus 20 manages the booking status of a meeting room, a reception room, a spare room, and the like available to the belonging members as an assembly site, using the calendar tool 31 provided by the external system 30.

Thus, in the present case, the calendar tool 31 stores the schedule information 311 in which each of plans of the adjustment initiator A and the like who may be participants of an assembly and the booking status of assembly sites available to the adjustment initiator A and the like is registered.

Note that the adjustment partner X may be a user of the time/date adjustment apparatus 20, but this is not essential. The adjustment partner X may use the calendar tool 31, but this is not essential. The adjustment partner X may use a calendar tool provided by a vendor different from a vendor of the calendar tool 31 used by the adjustment initiator A.

The time/date adjustment apparatus 20 includes functional blocks of a processing unit 21, a storage unit 22, and a communication unit 23. The time/date adjustment apparatus 20 includes a general computer such as a server computer including a processor such as a central processing unit (CPU), a memory such as a dynamic random access memory (DRAM), a storage such as a hard disk drive (HDD) and a solid state drive (SSD), an input device such as a keyboard, a mouse, and a touch panel, an output device such as a display, and a communication module such as a network interface card (NIC) (all of which are not illustrated).

The processing unit 21 is implemented by the processor of the computer. The processing unit 21 includes functional blocks of an authentication unit 211, an adjustment condition setting unit 212, and a time/date adjustment unit 213. These functional blocks are implemented by the processor of the computer executing a predetermined program loaded in the memory. Note that a part or all of these functional blocks may be implemented as hardware by an integrated circuit or the like.

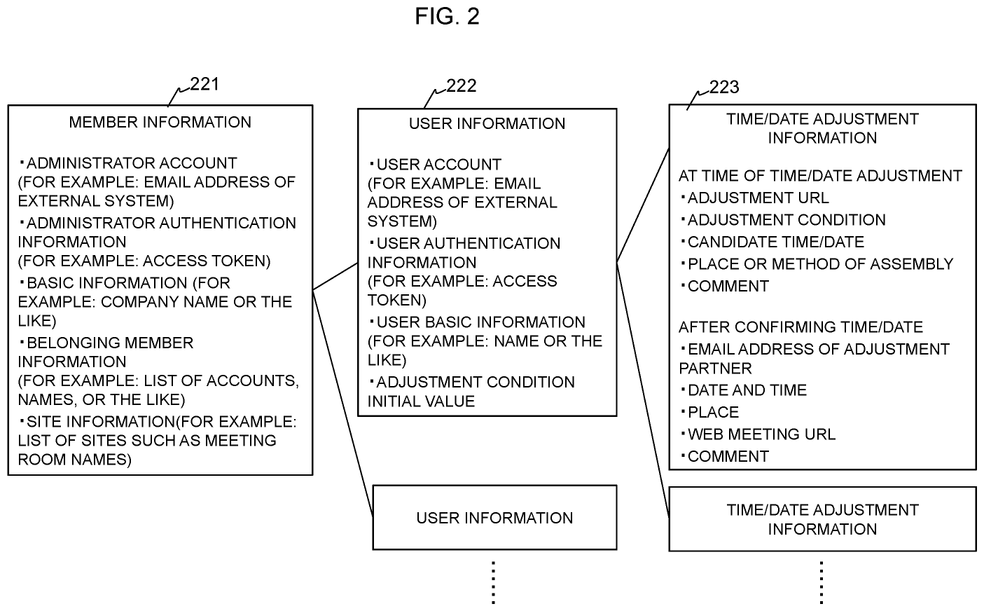

The authentication unit 211 accesses the external system 30 via the network 11, and for example, performs authentication processing in accordance with a protocol such as OAuth, using a user account (FIG. 2) included in user information 222 corresponding to the adjustment initiator (user) A stored by the storage unit 22. Note that the user account may be used in first authentication processing, and in second and following authentication processing, user authentication information (an access token or the like) (FIG. 2) transmitted from the external system 30 after the first authentication processing has ended can be used. Note that, after the authentication processing of the adjustment initiator A has completed, for example, the time/date adjustment unit 213 can refer to and update the schedule information 311 in which plans of the adjustment initiator A and the belonging member belonging to the same corporate member as the adjustment initiator A are registered and the schedule information 311 in which plans of assembly sites (a meeting room and the like) available to the adjustment initiator A and the belonging member belonging to the same corporate member as the adjustment initiator A are registered, which are stored in the calendar tool 31, via a web application programming interface (API).

The adjustment condition setting unit 212 causes the terminal apparatus 40A to display a condition setting screen for setting an adjustment condition including a plurality of items necessary for adjustment of a time/date of an assembly, sets the adjustment condition in response to an input from the adjustment initiator A on the condition setting screen, and registers results in time/date adjustment information 223 corresponding to the adjustment initiator A, stored in the storage unit 22. The items of the adjustment condition will be described below.

The time/date adjustment unit 213 refers to the schedule information 311 of the participants (which may or may not include the adjustment initiator A) of the assembly being managed by the calendar tool 31, and extracts first candidate time/dates that are available time/dates with no plans of the participants and satisfy the set adjustment condition. Then, the time/date adjustment unit 213 causes the terminal apparatus 40A to display a time/date editing screen for editing the first candidate time/dates, and determines second candidate time/dates in response to an editing operation from the adjustment initiator A on the time/date editing screen. The second candidate time/dates are registered in the time/date adjustment information 223 corresponding to the adjustment initiator A. When the first candidate time/dates are not edited by the adjustment initiator A, the first candidate time/dates and the second candidate time/dates are the same.

The time/date adjustment unit 213 issues an adjustment Uniform Resource Locator (URL) for the adjustment partner X to access a time/date adjustment screen. The adjustment URL may be issued as text, or may be issued as an image such as a QR code. The issued adjustment URL is transmitted to the adjustment partner X by the adjustment initiator A, using an electronic mail or the like. The adjustment URL corresponds to access information of the present invention.

Moreover, when the adjustment partner X accesses the adjustment URL by using the terminal apparatus 40X, the time/date adjustment unit 213 refers to the schedule information 311 of the participants at that time point being managed by the calendar tool 31 again, and extracts third candidate time/dates that are available time/dates with no plans of the participants, satisfy the set adjustment condition, and are within a range of the second candidate time/dates. Then, the time/date adjustment unit 213 causes the terminal apparatus 40X to display the time/date adjustment screen presenting the third candidate time/dates.

By extracting the third candidate time/dates, even if there is a change in the schedule of the participants during time from when the adjustment URL is issued to when the adjustment partner X accesses the adjustment URL, occurrence of a double booking due to such a change can be suppressed.

Furthermore, the time/date adjustment unit 213 registers the assembly time/date selected by the adjustment partner X out of the third candidate time/dates displayed on the time/date adjustment screen and confirmed in a confirmation screen, in the schedule information 311 of the participants being managed by the calendar tool 31, and registers the assembly time/date in the time/date adjustment information 223 corresponding to the adjustment initiator A stored by the storage unit 22. Note that the schedule of the participants may change even during a short period of time until the adjustment partner X selects the assembly time/date out of the third candidate time/dates displayed on the time/date adjustment screen and confirms the assembly time/date on the confirmation screen. Thus, the time/date adjustment unit 213 may perform final check that the selected assembly time/date is an available time/date of the participants and satisfies the adjustment condition, immediately before the assembly time/date is confirmed on the confirmation screen. Then, if the selected assembly time/date is no longer an available time/date, for example, a message such as “The designated time has been occupied. Select again” may be displayed on the terminal apparatus 40X, and the operation may be returned back to the time/date adjustment screen. With this configuration, occurrence of a double booking can be further suppressed.

The storage unit 22 is implemented by the memory and the storage of the computer. The storage unit 22 stores member information 221, the user information 222, and the time/date adjustment information 223. Note that the storage unit 22 may store information other than the information described above.

The communication unit 23 is implemented by the communication module of the computer. The communication unit 23 connects to the external system 30, the terminal apparatuses 40A and 40X, and the like via the network 11 and communicates various pieces of data and information therewith.

Note that a part or all of the above-described functional blocks constituting the time/date adjustment apparatus 20 may be implemented by hardware such as an integrated circuit. The time/date adjustment apparatus 20 may be implemented by a plurality of computers, and in that case, the above-described functional blocks may be distributedly deployed in the plurality of computers.

Next, FIG. 2 illustrates an example of the member information 221, the user information 222, and the time/date adjustment information 223 stored in the storage unit 22.

The member information 221 includes information related to each member who has conducted use registration with the time/date adjustment apparatus 20. Specifically, in a case of a corporate member, the member information 221 includes an administrator account, administrator authentication information, basic information, belonging member information, and site information.

The administrator account is information for a system administrator or the like of the corporate member (company or the like) to log in to the time/date adjustment apparatus 20. It is desirable that the administrator account be common to an account (for example, an email address of the system administrator or the like) for the system administrator or the like to access the external system 30. The administrator account is recorded at the time of use registration with the time/date adjustment apparatus 20.

The administrator authentication information is an access token or the like that is obtained from the external system 30 as success results of the authentication processing when the authentication unit 211 of the time/date adjustment apparatus 20 performs the authentication processing with the external system 30 for the first time, using the administrator account. After the administrator authentication information is obtained, the authentication unit 211 can more promptly perform the authentication processing with the external system 30 by using the administrator authentication information, without using the administrator account.

The basic information is a name of the corporate member (a company name or the like) or the like. The basic information is recorded at the time of use registration. The belonging member information is a list of names of belonging members belonging to the corporate member (company or the like), user accounts for accessing the external system 30, and the like. The belonging member information may be recorded at the time of use registration, or may be acquired from the external system 30 to be recorded on an assumption that all of the belonging members necessary for time/date adjustment already use the calendar tool 31.

The site information is a list of names of sites, such as a meeting room, a reception room, and a spare room, available to the belonging members belonging to the corporate member for an assembly, identification IDs of the sites in the external system, and the like. The site information may be recorded by the system administrator or the like at the time of use registration, or may be acquired from the external system 30 to be recorded on an assumption that the schedules of all of the sites necessary for time/date adjustment are already managed by the calendar tool 31.

In a case of an individual member, the administrator account, the administrator authentication information, and the basic information of the member information 221 are common to a user account, user authentication information, and user basic information of the user information 222 to be described below. These are recorded at the time of use registration. The belonging member information and the site information may be omitted.

The user information 222 includes information related to a user having a user account of the time/date adjustment apparatus 20 among the belonging members belonging to the corporate member, or related to an individual member themselves. The user information 222 is created when each user logs in to the time/date adjustment apparatus 20 for the first time, and is associated with the member information 221.

The user information 222 includes a user account, user authentication information, user basic information, and an adjustment condition initial value.

The user account is information for the user to log in to the time/date adjustment apparatus 20. It is desirable that the user account be common to an account (for example, an email address of the user) for the user to access the external system 30.

The user authentication information is an access token or the like that is obtained from the external system 30 as success results of the authentication processing when the authentication unit 211 performs the authentication processing with the external system 30 for the first time, using the user account. After the user authentication information is obtained, the authentication unit 211 can more promptly perform the authentication processing with the external system 30, using the user authentication information, without using the user account.

The user basic information is a name of the user or the like, and is read from the belonging member information of the member information 221 and is then recorded. The adjustment condition initial value is an initial value of the adjustment condition for an assembly set by the user, and is registered in the user information 222 in advance before time/date adjustment is performed (details will be described below).

The time/date adjustment information 223 is created in association with each user for each assembly in which the user is the adjustment initiator. In the time/date adjustment information 223, the adjustment URL, the adjustment condition, the candidate time/dates (first to third candidate time/dates), a place of the assembly, a method of the assembly, and a comment input by the adjustment initiator are sequentially recorded and updated at the time of time/date adjustment. In the time/date adjustment information 223, the email address input by the adjustment partner, the date and time of the assembly, the place of the assembly, the method of the assembly, the comment, and, if the method of the assembly is a web meeting, a web meeting URL to allow participation in the web meeting are recorded after the time/date is confirmed.

<Time/Date Adjustment Processing Performed by Time/Date Adjustment System 10>

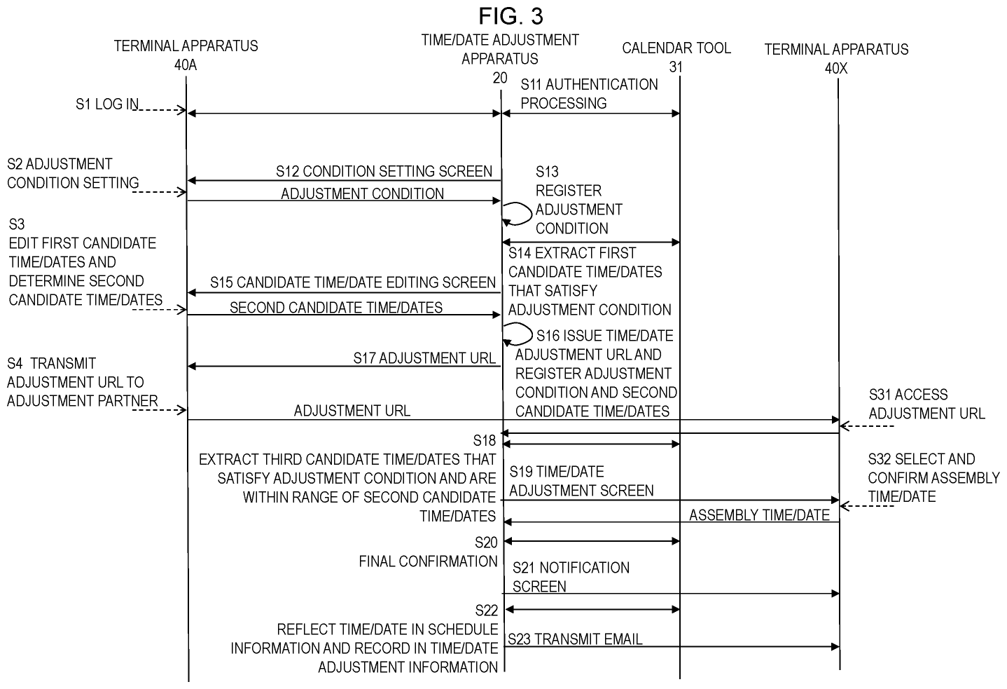

Next, FIG. 3 is a sequence diagram for illustrating an example of time/date adjustment processing performed by the time/date adjustment system 10.

First of all, the adjustment initiator A logs in to the time/date adjustment apparatus 20 via the network 11, using the terminal apparatus 40A (Step S1). Then, in response to the login of the adjustment initiator A, the authentication unit 211 of the time/date adjustment apparatus 20 performs the authentication processing with the external system 30, using the user account or the user authentication information (access token or the like) included in the user information 222 corresponding to the adjustment initiator A stored by the storage unit 22 (Step S11).

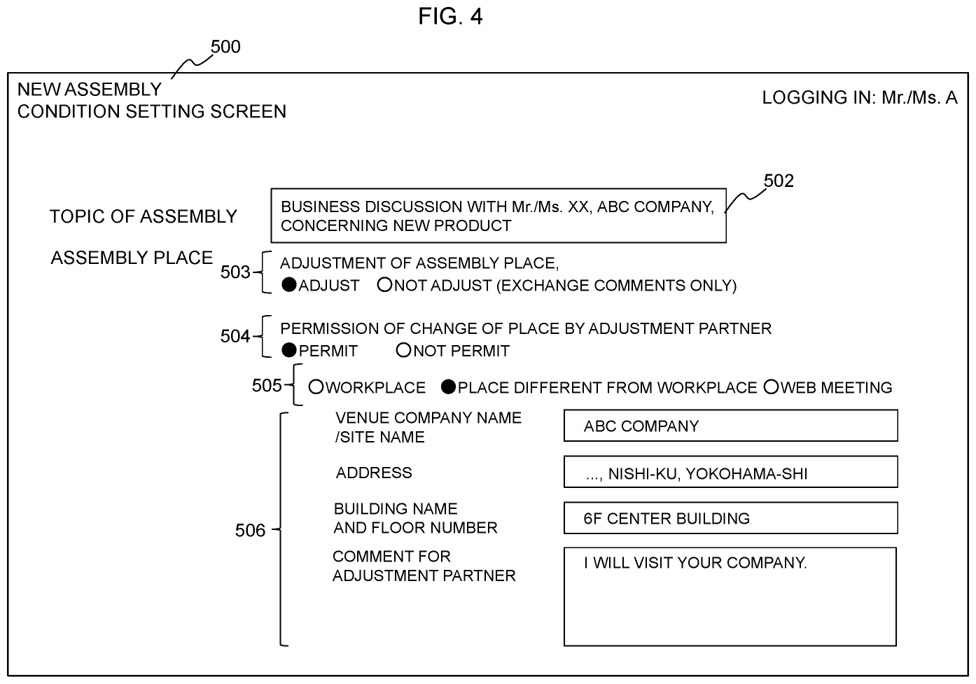

Next, the adjustment condition setting unit 212 of the time/date adjustment apparatus 20 causes the terminal apparatus 40A to display a condition setting screen 500 (FIG. 4, for example) for setting the adjustment condition (Step S12).

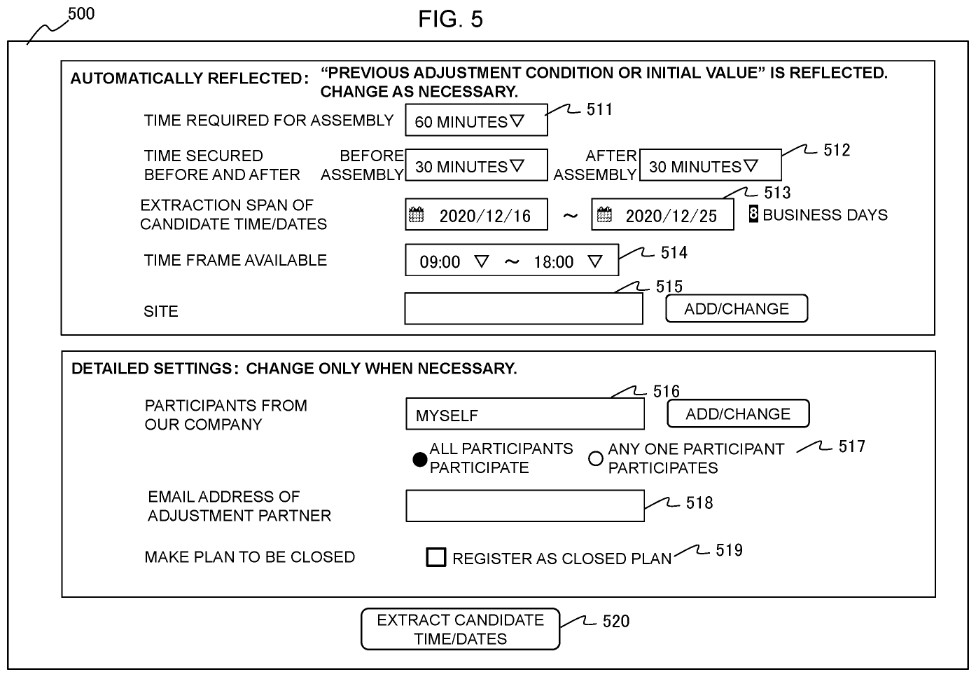

FIG. 4 and FIG. 5 are display examples of the condition setting screen 500 displayed in the terminal apparatus 40A. FIG. 4 illustrates an upper part of the condition setting screen 500, and FIG. 5 illustrates a lower part of the condition setting screen 500, which is displayed by scrolling down the screen from the upper part illustrated in FIG. 4.

As illustrated in FIG. 4, the condition setting screen 500 is provided with an input field 502 for inputting an assembly topic, a radio button 503 for selecting whether or not to adjust an assembly place, a radio button 504 for selecting whether or not to permit change of the designated assembly place by the adjustment partner, a radio button 505 for selecting a workplace, a place different from the workplace, or a web meeting as the assembly place, and an input field 506 for inputting a name, an address, and the like of the assembly place. Note that the input field 506 is provided when “workplace” or “place different from workplace” is selected in the radio button 505. When “web meeting” is selected in the radio button 505, a radio button (not illustrated) for selecting a videotelephony application as a method (means) of the assembly to be used for the web meeting is provided instead of the input field 506. When “not adjust” is selected in the radio button 503, only a comment input field (not illustrated) is provided instead of the radio buttons 504 and 505 and the input field 506.

Moreover, as illustrated in FIG. 5, the condition setting screen 500 is provided with a selection input field 511 for inputting time required for the assembly, selection input fields 512₁ and 512₂ for respectively inputting time secured before and after the assembly, a selection input field 513 for inputting an extraction span of the candidate time/dates, a selection input field 514 for inputting a time frame available for the assembly, and a selection input field 515 for inputting a site to be used for the assembly. Here, the time secured before and after the assembly is time for movement to the site, preparation work, withdrawal work, a break, and the like.

Note that, in display of the selection input fields 511 to 515, contents of the adjustment condition of the most recent assembly where the adjustment initiator A is the adjustment initiator are reflected with reference to the time/date adjustment information 223 associated with the adjustment initiator A. With this configuration, time and efforts taken by the adjustment initiator A to input the adjustment condition can be reduced. Note that whether or not to allow automatic reflection of the adjustment condition of the most recent assembly in the selection input fields 511 to 515 may be selected by designation of the adjustment initiator A.

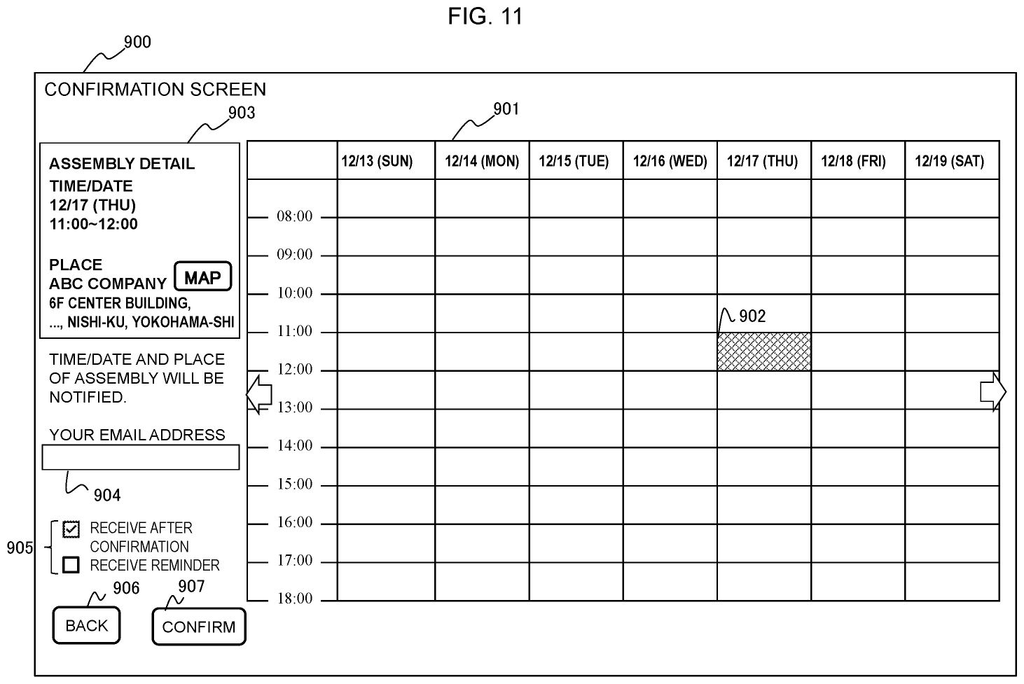

Furthermore, the condition setting screen 500 is provided with an input field 516 for designating and inputting one or more participants (which may not include the adjustment initiator A themselves) to participate in the assembly out of the belonging members of the corporate member to which the adjustment initiator A belongs, a radio button 517 for selecting an assembly participation condition of the participant(s) input to the input field 516, an input field 518 for omitting input of an email address by the adjustment partner X in a confirmation screen 900 (FIG. 11), a check box 519 for selecting whether or not to register the plan of the assembly as a closed plan, and an extract candidate time/date button 520 for confirming each input item and instructing extraction of candidate time/dates of the assembly.

Note that, when a plurality of participants are designated and input in the input field 516 and all of the input participants need to participate in the assembly, “all participants participate” may be selected in the radio button 517. When a plurality of participants are input in the input field 516 and it is sufficient that at least one of the input participants participates, “any one participant participates” may be selected in the radio button 517. When only one participant is input in the input field 516, “all participants participate” is automatically selected in the radio button 517, whereas when there is only one participant, subsequent operations, such as extraction of candidate time/dates, are all the same, regardless of whether “all participants participate” or “any one participant participates” is selected.

FIG. 3 is referred to again. When the adjustment initiator A inputs each item of the adjustment condition and performs operation on the extract candidate time/date button 520 on the condition setting screen 500 displayed in the terminal apparatus 40A (Step S2), the adjustment condition setting unit 212 of the time/date adjustment apparatus 20 creates, in response to the operation, new time/date adjustment information 223 in association with the user information 222 of the adjustment initiator A and causes the storage unit 22 to store the time/date adjustment information 223, and registers the set adjustment condition in the time/date adjustment information 223 (Step S13).

In the present case, the following description will be given based on an assumption that, for example, as illustrated in FIG. 4 and FIG. 5, as the adjustment condition, the assembly name is set to “business discussion with Mr./Ms. xx, ABC company, concerning new product”, the change of the designated assembly place by the adjustment partner is set to “permit”, the assembly place is set to “ABC company”, which is different from the workplace, the time required for the assembly is set to “60 minutes”, the time secured before and after the assembly is each set to “30 minutes”, the extraction span of the candidate time/dates is set to 8 business days from “2020/12/16” to “2020/12/25”, the time frame available is set to “09:00 to 18:00”, the site is set to “not designated”, the input of participants is set to “myself (adjustment initiator A)”, the assembly participation condition of the input participants is set to “all participants participate”, the email address of the adjustment partner is set to “not designated”, and registration of the plan of the assembly is set to “open to public”.

Next, the time/date adjustment unit 213 reads the adjustment condition registered in the time/date adjustment information 223 of the adjustment initiator A from the storage unit 22, refers to the schedule information 311 of the participants managed by the calendar tool 31 of the external system 30, and extracts the first candidate time/dates that are available time/dates of the participants at the current time point and satisfy the adjustment condition (Step S14). Specifically, in the present case, time that is the available time/dates of the adjustment initiator A, a time frame from 09:00 to 18:00 on business days from 2020/12/16 to 2020/12/25, and in which 60 minutes as the time required for the assembly can be secured is extracted, and further, time in which 30 minutes as the time secured before the assembly and 30 minutes as the time secured after the assembly cannot be secured is excluded, and the first candidate time/dates are thereby determined.

Note that, when the adjustment initiator A is a secretary or the like of an actual participant, who performs time/date adjustment on their behalf, and only one actual participant different from the adjustment initiator A is input to the input field 516 of the condition setting screen 500, the schedule information 311 of the actual participant is referred to, and the first candidate time/dates that are available time/dates of the actual participant and satisfy the adjustment condition are extracted. When a plurality of participants (which may or may not include the adjustment initiator A) are input to the input field 516 of the condition setting screen 500 and “all participants participate” is selected in the radio button 517, the schedule information 311 of all of the participants is referred to, and the first candidate time/dates that are available time/dates common to all of the participants and satisfy the adjustment condition are extracted. In contrast, when a plurality of participants (which may or may not include the adjustment initiator A) are input to the input field 516 of the condition setting screen 500 and “any one participant participates” is selected in the radio button 517, the schedule information 311 of all of the participants is referred to, and the first candidate time/dates that are available time/dates of at least one of all of the participants and satisfy the adjustment condition are extracted. The same holds true for cases in which the second and third candidate time/dates are extracted, which will be described below.

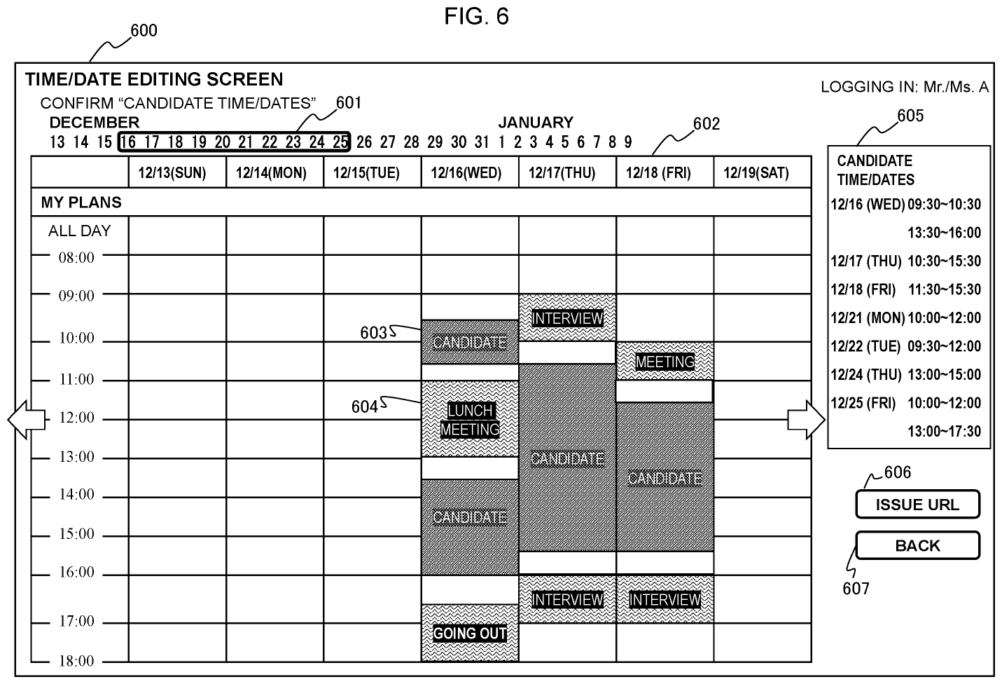

Next, the time/date adjustment unit 213 causes the terminal apparatus 40A to display a time/date editing screen 600 (FIG. 6, for example) presenting the first candidate time/dates (Step S15).

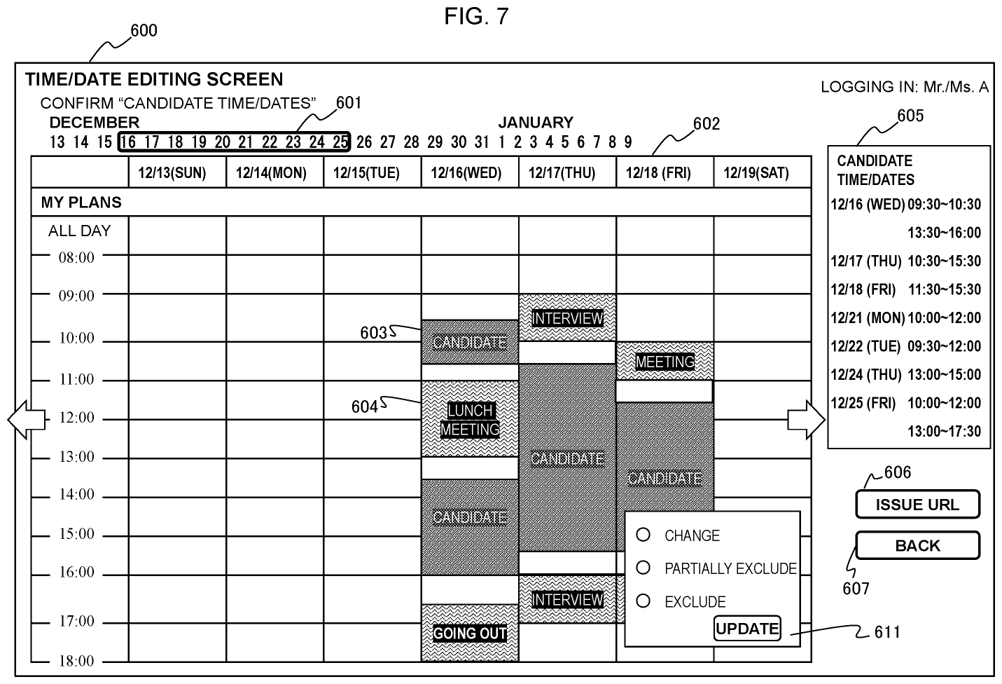

FIG. 6 and FIG. 7 illustrate display examples of the time/date editing screen 600 displayed in the terminal apparatus 40A. On the time/date editing screen 600, a candidate time/date span frame 601, a calendar 602 displayed in a grid pattern with its horizontal axis representing dates and vertical axis representing time, and a candidate time/date list 605 in which the first candidate time/dates are listed per day are displayed. On the time/date editing screen 600, an issue URL button 606 and a back button 607 are provided.

The candidate time/date span frame 601 indicates a span including the first candidate time/dates out of the extraction span of the candidate time/dates input to the selection input field 513 of the condition setting screen 500.

On the calendar 602, based on the schedule information 311 of the participant managed by the calendar tool 31, existing plan frames 604 indicating plans of the participant within a display span on the calendar 602 and first candidate time/date frames 603 are displayed in different colors or the like so that the existing plan frames 604 and the first candidate time/date frames 603 can be distinguished from each other. With this configuration, the adjustment initiator A can edit the first candidate time/dates while checking existing plans of the participant. Note that, in the present case, the participant is the adjustment initiator A only, and thus only existing plans of the adjustment initiator A are displayed as the existing plan frames 604 in the calendar 602 of the time/date editing screen 600; however, when there are a plurality of participants, existing plans of all of the participants are displayed as the existing plan frames 604. In this case, names of the participants may be displayed in the existing plan frames 604, or the existing plan frames 604 may be assigned different colors, so as to allow making a distinction as to whose existing plan a plan is among the plurality of participants.

In the candidate time/date list 605, the first candidate time/dates are listed and displayed per day.

The adjustment initiator A can edit the first candidate time/dates, using a pop-up screen 611 (FIG. 7) to be displayed by selecting the first candidate time/date frame 603 in the calendar 602. For example, when the pop-up screen 611 is displayed by selecting a frame of 10:30 to 15:30 on December 17th and then “change” on the pop-up screen 611 is selected, 10:30 being the starting time of the frame may be set to later time, and 15:30 being the ending time may be set to earlier time. When “partially exclude” on the pop-up screen 611 is selected, a part of the frame, for example, 12:00 to 13:00, can be excluded from the first candidate time/dates. When “exclude” on the pop-up screen 611 is selected, the frame can be excluded from the first candidate time/dates. The editing results of the first candidate time/dates in the calendar 602 are reflected in the candidate time/date list 605. Note that editing of the first candidate time/dates may be performed with an operation, such as drag and drop, on the screen, depending on an operation of an input device (a mouse, a touch panel, or the like) provided for the terminal apparatus 40A. The same holds true for other screen operations in the terminal apparatuses 40A and 40X.

Note that the adjustment initiator A can edit the first candidate time/dates also in the candidate time/date list 605.

The issue URL button 606 is a button for confirming the editing results (second candidate time/dates) of the first candidate time/dates by the adjustment initiator A in the calendar 602 and instructing issuing of the adjustment URL for the adjustment partner to access the time/date adjustment screen. The back button 607 is a button for returning back to the condition setting screen 500.

In the present case, the following description will be given based on an assumption that the adjustment initiator A excludes 15:00 to 16:00 on December 16th from the first candidate time/dates on the time/date editing screen 600.

FIG. 3 is referred to again. When the adjustment initiator A edits the first candidate time/dates as necessary and performs operation on the issue URL button 606 on the time/date editing screen 600 displayed in the terminal apparatus 40A (Step S3), next, the time/date adjustment unit 213 of the time/date adjustment apparatus 20 issues the adjustment URL, and registers the adjustment URL and the second candidate time/dates in the time/date adjustment information 223 (created in Step S13) corresponding to the adjustment initiator A (Step S16). Note that the second candidate time/dates may be written over the first candidate time/dates registered in the time/date adjustment information 223.

Next, the time/date adjustment unit 213 causes the terminal apparatus 40A to display the issued adjustment URL and a message for instructing transmission of the adjustment URL to the adjustment partner (Step S17).

Next, in response to the message, the adjustment initiator A copies the adjustment URL displayed in the terminal apparatus 40A, pastes the adjustment URL to an electronic mail or the like, and transmits the adjustment URL to the terminal apparatus 40X of the adjustment partner X (Step S4).

Next, when the adjustment partner X who has received the adjustment URL accesses the adjustment URL by using the terminal apparatus 40X (Step S31), the time/date adjustment unit 213 of the time/date adjustment apparatus 20 reads the adjustment condition and the second candidate time/dates registered in the time/date adjustment information 223 of the adjustment initiator A corresponding to the adjustment URL from the storage unit 22, refers to the schedule information 311 of the participant managed by the calendar tool 31, and extracts the third candidate time/dates that are available time/dates of the participant at the current time point, satisfy the adjustment condition, and are within a range of the second candidate time/dates (Step S18).

In the present case, it is assumed that a plan at 13:00 to 14:00 on December 17th (Thursday) is added to the schedule information 311 of the adjustment initiator A during time from when the adjustment URL is issued to when the adjustment partner X accesses the adjustment URL. In this case, the third candidate time/dates are those obtained by excluding, from the second candidate time/dates, 12:30 to 14:30 on December 17th (Thursday) with “30 minutes” as the time secured before and after the assembly being taken into consideration. In other words, the “time secured before and after” of the adjustment condition is also applied to the additional plan of the adjustment initiator A.

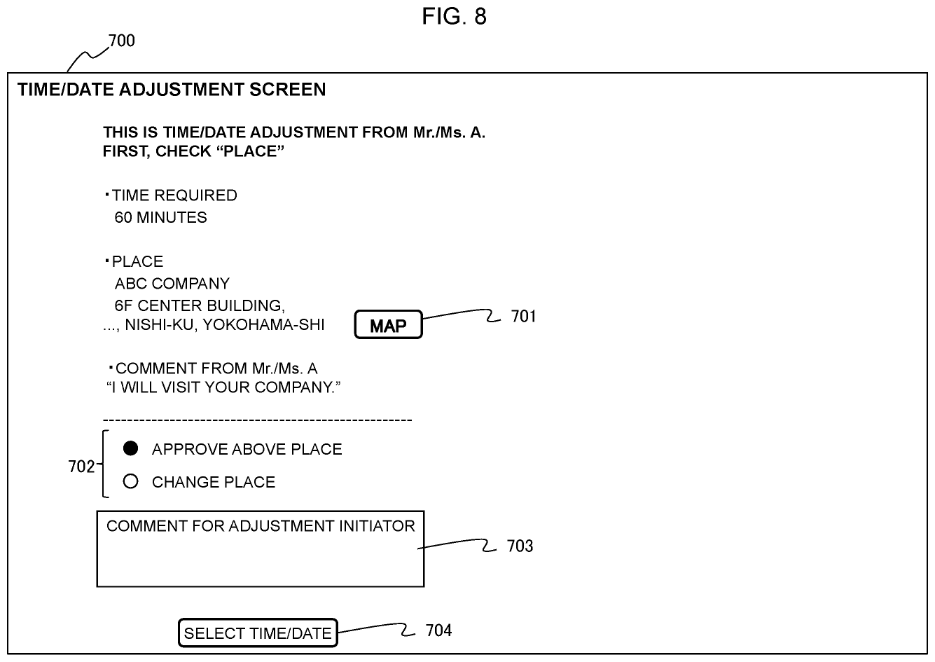

Next, the time/date adjustment unit 213 causes the terminal apparatus 40X to display a time/date adjustment screen 700 (FIG. 8) (Step S19).

FIG. 8 illustrates a display example of the time/date adjustment screen 700. The time/date adjustment screen 700 is a screen for the adjustment partner X to check the place of the assembly. On the time/date adjustment screen 700, the assembly place (a site name, an address, and the like) that the adjustment initiator A has input to the input field 506 of the condition setting screen 500 (FIG. 4) and a MAP button 701 for presenting the assembly place on a map are displayed. Moreover, on the time/date adjustment screen 700, a radio button 702 for selecting whether or not the assembly place designated by the adjustment initiator A is good, an input field 703 for inputting a response comment to the adjustment initiator A, and a select time/date button 704 are provided. Note that it is arranged that the adjustment partner X can select the radio button 702 only when the adjustment initiator A selects “permit change of the place by the adjustment partner” in the radio button 504 on the condition setting screen 500 (FIG. 4). Thus, when the adjustment initiator A selects “not permit change of the place by the adjustment partner” in the radio button 504 on the condition setting screen 500, the adjustment partner X cannot select whether or not the assembly place designated by the adjustment initiator A is good.

When the assembly place displayed on the time/date adjustment screen 700 is not inconvenient, the adjustment partner X may select “approve above place” on the radio button 702 and perform operation on the select time/date button 704. In contrast, when the assembly place displayed on the time/date adjustment screen 700 is inconvenient, the adjustment partner X may select “change place” in the radio button 702. In response to “change place” being selected, an input field (not illustrated) for the adjustment partner X to input a changed destination (a place name, an address, a building name, a floor number, and the like) of the assembly place is additionally displayed on the time/date adjustment screen 700, and the adjustment partner X may input a changed destination of the assembly place to the input field and perform operation on the select time/date button 704.

Note that, when the adjustment initiator A selects “not adjust assembly place” in the radio button 503 on the condition setting screen 500, the display field and the input field for the assembly place are not displayed.

When the adjustment initiator A selects “web meeting” in the radio button 505 on the condition setting screen 500, a message indicating that a web meeting is to be held and a name of a videotelephony application as a method (means) of the assembly to be used for the web meeting are displayed on the time/date adjustment screen 700 instead of the assembly place, and description indications of the radio button 702 are changed to “approve above” and “change” (not illustrated), for example. When the videotelephony application displayed on the time/date adjustment screen 700 is not inconvenient, the adjustment partner X may select “approve above” in the radio button 702 and perform operation on the select time/date button 704. In contrast, when the videotelephony application displayed on the time/date adjustment screen 700 is inconvenient, the adjustment partner X may select “change” in the radio button 702. When the adjustment partner X selects “change”, the adjustment partner X may input, for example, “I do not use a first videotelephony application. I request to use a second videotelephony application” or the like to the comment input field, and perform operation on the select time/date button 704.

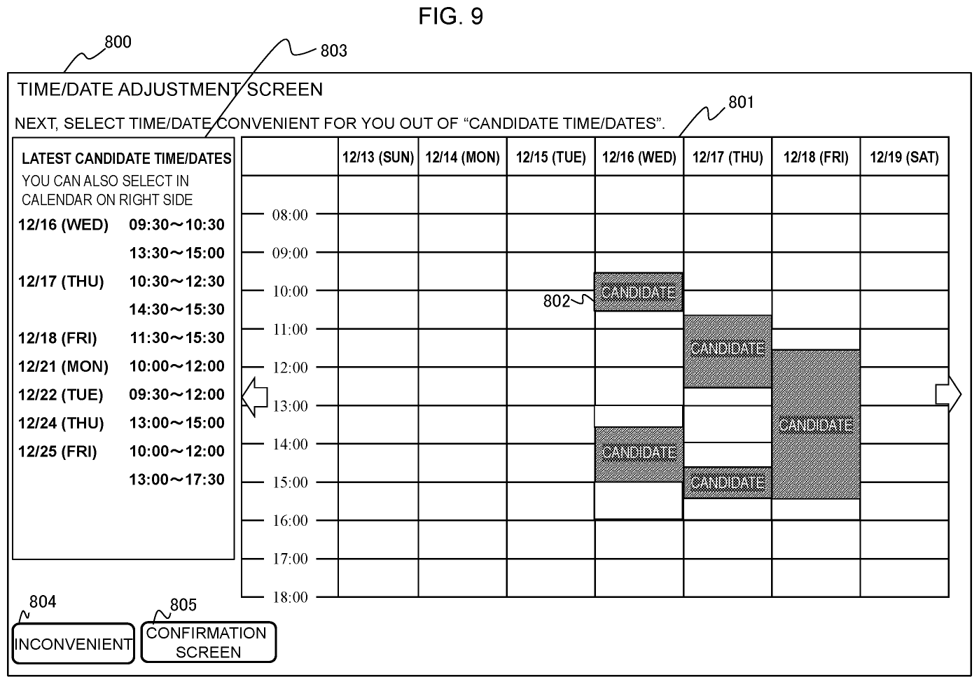

When the adjustment partner X performs operation on the select time/date button 704 on the time/date adjustment screen 700, a time/date adjustment screen 800 (FIG. 9) is displayed in the terminal apparatus 40X.

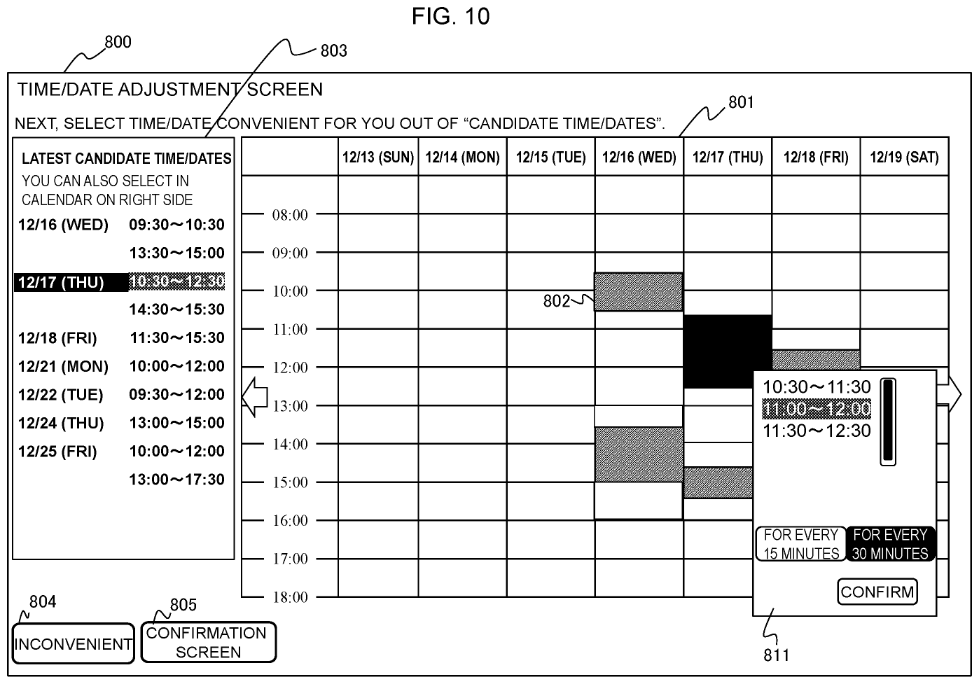

FIG. 9 and FIG. 10 illustrate display examples of the time/date adjustment screen 800 presenting the third candidate time/dates. On the time/date adjustment screen 800, a calendar 801 displayed in a grid pattern with its horizontal axis representing dates and vertical axis representing time and a candidate time/date list 803 in which the third candidate time/dates are listed per day are displayed. On the time/date adjustment screen 800, an inconvenient button 804 and a confirmation screen button 805 are provided.

In the calendar 801, third candidate time/date frames 802 are displayed in different colors or the like so that the third candidate time/date frames 802 can be distinguished from other frames. Note that, in the calendar 801, existing plans of the participant are not displayed, unlike the calendar 602 of the time/date editing screen 600 (FIG. 6). Thus, for the adjustment partner X, privacy of the participant can be protected.

In the candidate time/date list 803, the third candidate time/dates are listed and displayed per day.

The adjustment partner X can select the assembly time/date by selecting one of the third candidate time/date frames 802 in the calendar 801. Note that, when a third candidate time/date frame 810 (FIG. 10) longer than “60 minutes” as the time required for the assembly is selected, a pop-up screen 811 (FIG. 10) is displayed. On the pop-up screen 811, candidate time/dates that can be set within time of the selected frame are presented. In the case of FIG. 10, on the pop-up screen 811, the starting time of the candidate time/dates can be shifted at intervals for every 15 minutes or for every 30 minutes; however, the intervals may be freely set. The starting time of the candidate time/dates may be freely set. The adjustment partner X can determine the assembly time/date by selecting one of the time/date candidates presented on the pop-up screen 811.

In the present case, the following description will be given based on an assumption that the adjustment partner X determines 11:00 to 12:00 on December 17th as the assembly time/date on the time/date adjustment screen 800.

The inconvenient button 804 is a button on which operation is performed when the third candidate time/dates presented on the time/date adjustment screen 800 are inconvenient. When the adjustment partner X performs operation on the inconvenient button 804, the adjustment initiator A is notified that suggested candidate time/dates are inconvenient. In this case, the adjustment initiator A changes the adjustment condition, and executes the time/date adjustment processing again.

The confirmation screen button 805 is a button for checking with the determined assembly time/date. When the adjustment partner X performs operation on the confirmation screen button 805, the confirmation screen 900 (FIG. 11) for adjustment partner X themselves to check the assembly time/date selected and determined out of the third candidate time/dates is displayed in the terminal apparatus 40X.

FIG. 11 illustrates a display example of the confirmation screen 900. On the confirmation screen 900, a calendar 901 displayed in a grid pattern with its horizontal axis representing dates and vertical axis representing time and an assembly detail 903 are displayed.

In the calendar 901, an assembly time/date frame 902 selected and determined on the time/date adjustment screen 800 by the adjustment partner X themselves is displayed in different colors or the like so that the assembly time/date frame 902 can be distinguished from other frames. In the assembly detail 903, the time/date and the place of the assembly are displayed. Note that, when the adjustment partner X selects “change place” in the radio button 702 and enters the changed destination of the site in the input field 703 on the time/date adjustment screen 700 (FIG. 8), the place name, the address, the building name, the floor number, and the like that the adjustment partner X has input as the changed destination of the assembly place are displayed in the assembly detail 903. When the adjustment partner X has input a comment on the time/date adjustment screen 700, the comment is displayed in the assembly detail 903.

The confirmation screen 900 is provided with an input field 904 for the adjustment partner X to input an email address of the adjustment partner X, a check box 905 for setting a timing of transmitting an email for notifying the adjustment partner X of holding of the assembly, a back button 906 for returning back to the time/date adjustment screen 800, and a confirmation button 907 for confirming the details displayed on the confirmation screen 900.

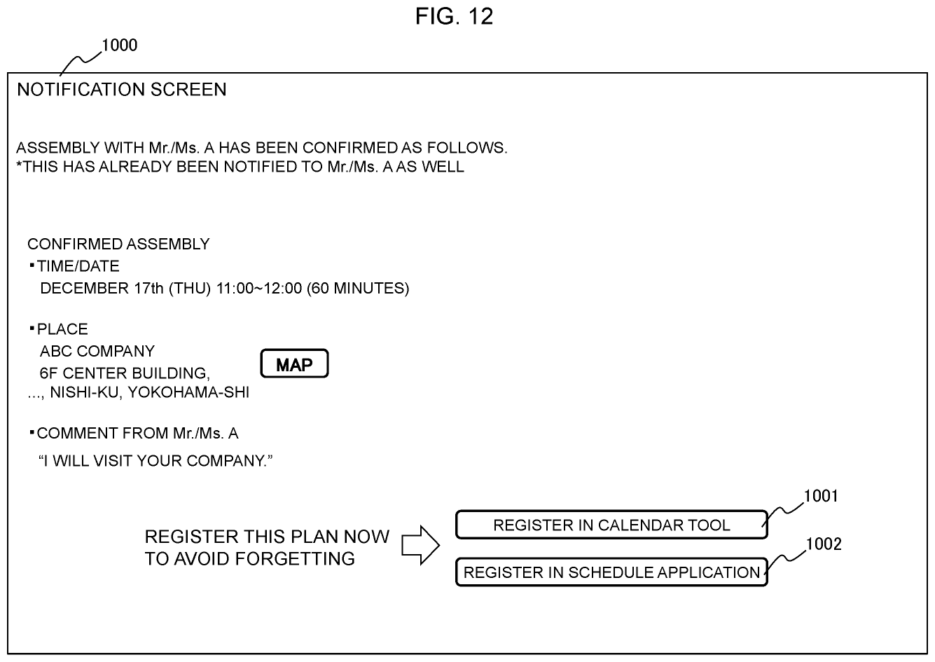

FIG. 3 is referred to again. When the adjustment partner X inputs the email address of the adjustment partner X to the input field 904 and performs operation on the confirmation button 907 on the confirmation screen 900 (FIG. 11) displayed in the terminal apparatus 40X (Step S32), the time/date adjustment unit 213 refers to the schedule information 311 of the participant managed by the calendar tool 31, and performs final check that the assembly time/date confirmed on the confirmation screen 900 is an available time/date of the participant at the current time point, satisfies the adjustment condition, and is within a range of the second candidate time/dates (Step S20). Here, when the confirmed assembly time/date is no longer an available time/date of the participant or no longer satisfies the adjustment condition, for example, a message such as “The designated time has been occupied. Select again” may be displayed on the terminal apparatus 40X, and the processing may be brought back to Step S18 and may resume from the operation of the adjustment partner X on the time/date adjustment screen 800. In contrast, when final check is successfully performed that the confirmed assembly time/date is an available time/date of the participant, satisfies the adjustment condition, and is within a range of the second candidate time/dates, a notification screen 1000 (FIG. 12) presenting the time/date of the assembly and the like confirmed by the adjustment partner X themselves is displayed in the terminal apparatus 40X (Step S21).

FIG. 12 illustrates a display example of the notification screen 1000. On the notification screen 1000, the confirmed time/date of the assembly, the place, the comment from the adjustment initiator A, and the like are displayed. On the notification screen 1000, a register button 1001 for the calendar tool and a register button 1002 for a schedule application are provided. When the adjustment partner X uses the calendar tool 31 and performs operation on the register button 1001, the adjustment partner X can register the plan of the confirmed assembly in the calendar tool 31 as a plan of the adjustment partner X themselves. When the adjustment partner X performs operation on the register button 1002, the adjustment partner X can register the plan of the confirmed assembly in an application program (for example, Outlook (trademark) or the like) for schedule management used by the adjustment partner X.

When final check is successfully performed that the confirmed assembly time/date is an available time/date of the participant, satisfies the adjustment condition, and is within a range of the second candidate time/dates in the final check of Step S20, the time/date adjustment unit 213 registers the plan of the assembly with the adjustment partner X in the schedule information 311 of the participant managed by the calendar tool 31. The time/date adjustment unit 213 registers the email address of the adjustment partner X, the date and time of the assembly, the place thereof, and the like in the time/date adjustment information 223 (created in Step S13) corresponding to the adjustment initiator A stored by the storage unit 22 (Step S22). Note that, when the assembly is a web meeting, instead of the place, the time/date adjustment unit 213 issues a web meeting URL, and registers the web meeting URL in the time/date adjustment information 223.

Note that, when a plurality of participants are input to the input field 516 of the condition setting screen 500 (FIG. 5) and “all participants participate” is selected in the radio button 517, the time/date adjustment unit 213 registers the plan of the assembly with the adjustment partner X in the schedule information 311 of all of the participants managed by the calendar tool 31. When a plurality of participants are input to the input field 516 of the condition setting screen 500 and “any one participant participates” is selected in the radio button 517, the plan of the assembly with the adjustment partner X may be registered in the schedule information 311 of all of the persons having an available time/date on the confirmed assembly time/date out of the plurality of participants input to the input field 516, or one person may be selected out of persons having an available time/date on the confirmed assembly time/date and the plan of the assembly with the adjustment partner X may be registered in the schedule information 311 of the one selected person. Note that, regarding selection of the participant, the time/date adjustment unit 213 may perform selection in accordance with a predetermined rule, or the adjustment initiator A may perform selection.

Next, the time/date adjustment unit 213 transmits an email (including a web meeting URL, if the assembly is a web meeting) for notifying the adjustment partner X of holding of the assembly to the terminal apparatus 40X at a timing in accordance with the setting for the check box 905 on the confirmation screen 900 (FIG. 11) by the adjustment partner X (Step S23). Through the above processing, the time/date adjustment processing performed by the time/date adjustment system 10 ends.

According to the time/date adjustment processing described above, the time/date of the assembly in which the participant and the adjustment partner X participate can be easily and efficiently set without causing a double booking.

According to the time/date adjustment processing, the confirmed time/date of the assembly and the like can be registered in the calendar tool 31 used by the participant. Therefore, time and efforts for conventionally required manual registration of the schedule in the calendar tool 31 can be eliminated.

Moreover, according to the time/date adjustment processing, the place of the assembly or the method of the assembly designated by the adjustment initiator A can be changed by the adjustment partner X.

In addition, from the standpoint of the adjustment initiator A, operations from extraction of the candidate time/dates to transmitting the candidate time/dates to the adjustment partner X can be performed in a short period of time (for example, approximately 30 seconds), and after transmitting the candidate time/dates to the adjustment partner X, the adjustment initiator A only has to wait and can have important operations regarding time/date adjustment automatically completed, which includes not only determination of the time/date but also adjustment of the place of the assembly or the method of the assembly and registration of the plan. This can significantly reduce time and efforts for the operations regarding time/date adjustment.

<First Modification of Time/Date Adjustment Processing Performed by Time/Date Adjustment System 10>

Next, a first modification of the time/date adjustment processing performed by the time/date adjustment system 10 will be described. In the first modification, the adjustment initiator A can set, in advance, the adjustment condition initial value for the assembly in the user information 222 corresponding to the adjustment initiator A stored by the storage unit 22 of the time/date adjustment apparatus 20.

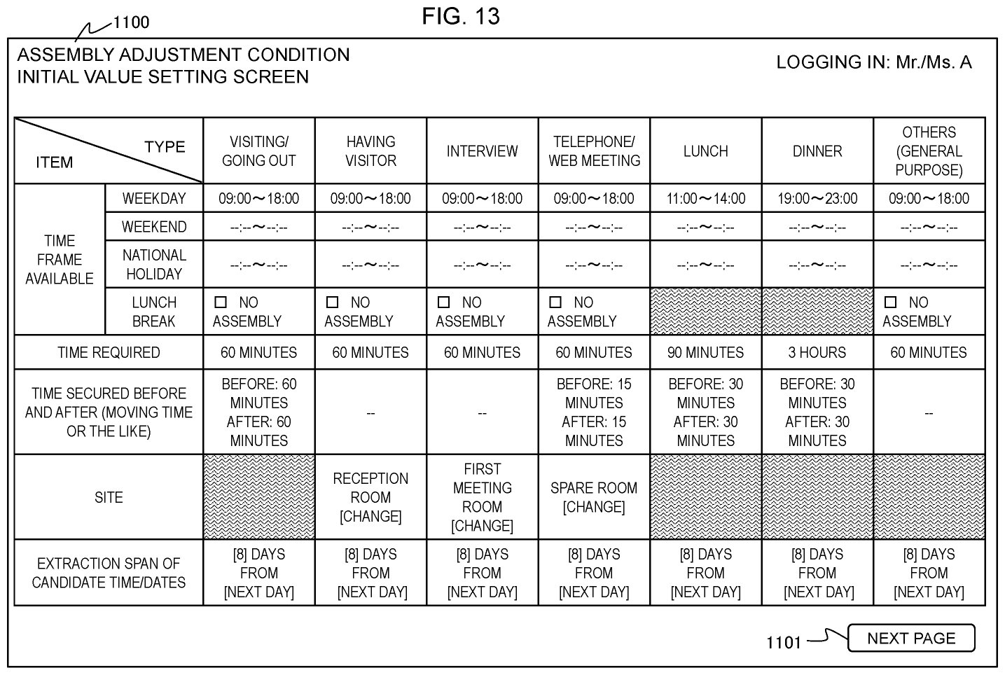

FIG. 13 illustrates a display example of an initial value setting screen 1100 for setting the adjustment condition initial value for the assembly. The initial value setting screen 1100 is displayed in the terminal apparatus 40A in response to the adjustment initiator A logging in to the time/date adjustment apparatus 20 by using the terminal apparatus 40A and performing a predetermined operation.

On the initial value setting screen 1100, an initial value of each item of the adjustment condition can be set for each type of assembly. As the types of assemblies, visiting/going out, having a visitor, an interview, a telephone/web meeting, lunch, dinner, and others (general purpose) are provided. As the items of the adjustment condition, the time frame available for assembly for each day of the week and national holiday, the time required for the assembly, the time secured before and after, the site, and the extraction span of the candidate time/dates are provided. Note that the types of assemblies may be added or deleted by the adjustment initiator A.

Note that, on the initial value setting screen 1100, depending on types of assembly, there are items (for example, the site in a case of visiting/going out and the like) to which initial values cannot be set. Even if an item accepts setting of an initial value thereto, there may or may not be input of the initial value, and there may be items to which initial values are not input.

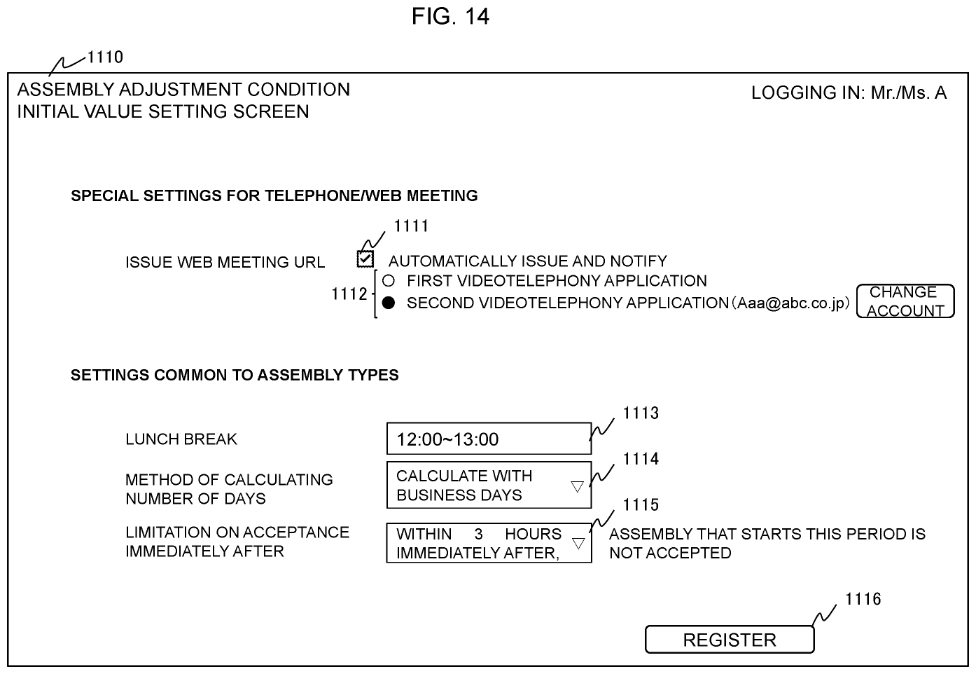

The initial value setting screen 1100 is provided with a next page button 1101 for proceeding to the next page. When there is operation performed on the next page button 1101, an initial value setting screen 1110 (FIG. 14) is displayed in the terminal apparatus 40A.

FIG. 14 illustrates a display example of the initial value setting screen 1110. The initial value setting screen 1110 is provided with a check box 1111 for selecting whether or not to allow automatic issuing and notification of a URL for connection for a web meeting to the adjustment partner and a radio button 1112 for selecting a videotelephony application to be used in the web meeting. A user account and a password of the videotelephony application to be used may be registered in the user information 222 by the adjustment initiator A.

Alternatively, the initial value setting screen 1110 is provided with an input field 1113 for inputting lunch break hours, a selection input field 1114 for selecting and inputting a method of calculating the number of days for the extraction span of the candidate time/dates, a selection input field 1115 for inputting a length of time immediately after a timing not extracted as the candidate time/date at the timing of extracting the candidate time/date, and a register button 1116. When there is operation performed on the register button 1116, the initial values of the adjustment condition input to the initial value setting screens 1100 and 1110 are registered in the user information 222 corresponding to the adjustment initiator A stored in the storage unit 22 of the time/date adjustment apparatus 20. The following description will be given based on an assumption that the initial values of the adjustment condition are set as illustrated in FIG. 13 and FIG. 14.

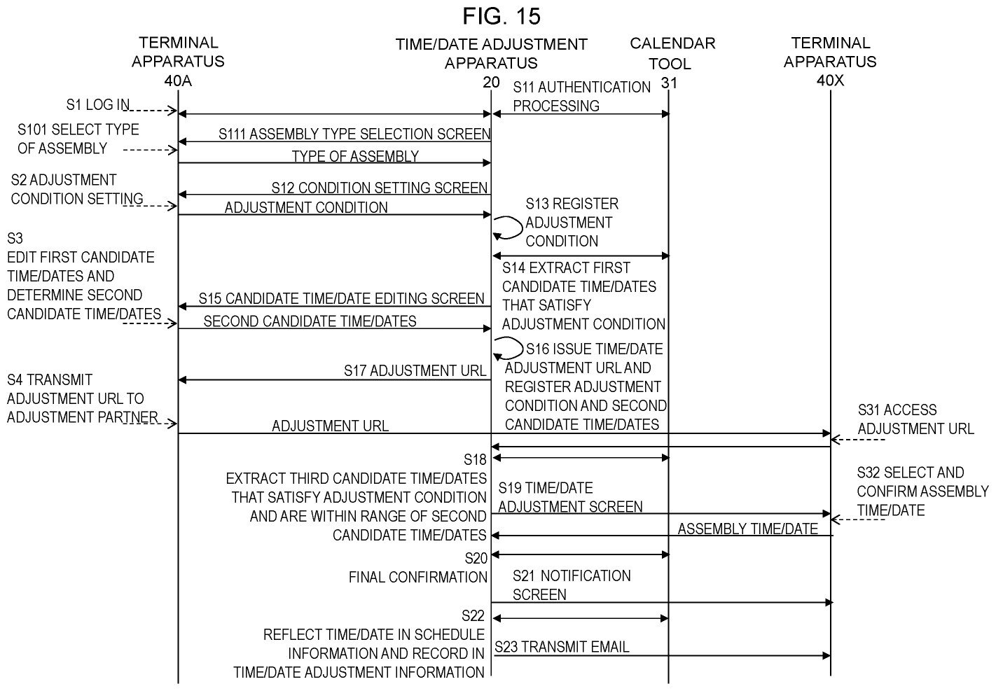

Next, FIG. 15 is a sequence diagram for illustrating a first modification of the time/date adjustment processing performed by the time/date adjustment system 10.

In the first modification, Step S101 is added between Step S1 and Step S2 performed by the terminal apparatus 40A in the time/date adjustment processing illustrated in FIG. 3, and Step S111 is added between Step S11 and Step S12 performed by the time/date adjustment apparatus 20. Note that operations in common to the first modification and the time/date adjustment processing of FIG. 3 are denoted by the same step numbers, and thus description thereof will be omitted as appropriate.

First of all, the adjustment initiator A logs in to the time/date adjustment apparatus 20 via the network 11, using the terminal apparatus 40A (Step S1), and in response to this, the authentication unit 211 of the time/date adjustment apparatus 20 performs the authentication processing with the external system 30 (Step S11).

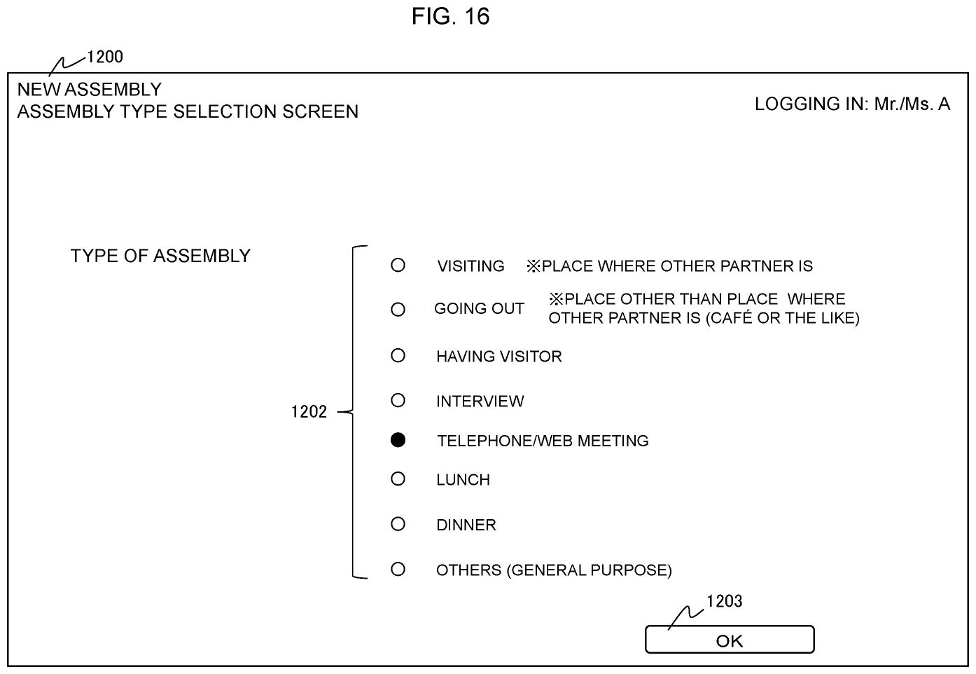

Next, the adjustment condition setting unit 212 of the time/date adjustment apparatus 20 causes the terminal apparatus 40A to display an assembly type selection screen 1200 (FIG. 16) for selecting a type of assembly (Step S111).

FIG. 16 illustrates a display example of the assembly type selection screen 1200 displayed in the terminal apparatus 40A.

The assembly type selection screen 1200 is provided with a radio button 1202 for selecting a type of assembly and an OK button 1203 for confirming selection results in the radio button 1202.

FIG. 15 is referred to again. When a type of assembly is selected using the radio button 1202 and operation is performed on the OK button 1203 on the assembly type selection screen 1200 displayed in the terminal apparatus 40A (Step S101), next, the adjustment condition setting unit 212 of the time/date adjustment apparatus 20 causes the terminal apparatus 40A to display the condition setting screen 500 (FIG. 4 and FIG. 5) for setting the adjustment condition (Step S12). Note that, in the selection input fields 511 to 515 of the condition setting screen 500 displayed here, the initial values of the adjustment condition corresponding to the type of assembly selected in Step S101 are reflected with reference to the adjustment condition initial value registered in the user information 222 corresponding to the adjustment initiator A stored in the storage unit 22. Depending on the type of assembly selected in Step S101, the radio buttons 503, 504, and 505 and the input field 506 of the condition setting screen 500 are changed to one of three patterns, i.e., a pattern of adjusting the assembly place, a pattern of making an adjustment for a web meeting, or a pattern other than the above (only a comment input).

The following processing is similar to the time/date adjustment processing of FIG. 3, and thus description thereof will be omitted.

According to the first modification of the time/date adjustment processing described above, in addition to effects similar to those of the time/date adjustment processing of FIG. 3, time and efforts taken by the adjustment initiator A to input the adjustment condition depending on a type of assembly can be significantly reduced.

In addition, in time/date adjustment in business, a pattern is, to a certain degree, determined for each situation (type of assembly), such as an interview, a sales visit, having a visitor, and a web meeting. Thus, once a pattern for each situation is registered in advance, by merely selecting the situation, the candidate time/dates can be instantly extracted.

<Second Modification of Time/Date Adjustment Processing Performed by Time/Date Adjustment System 10>

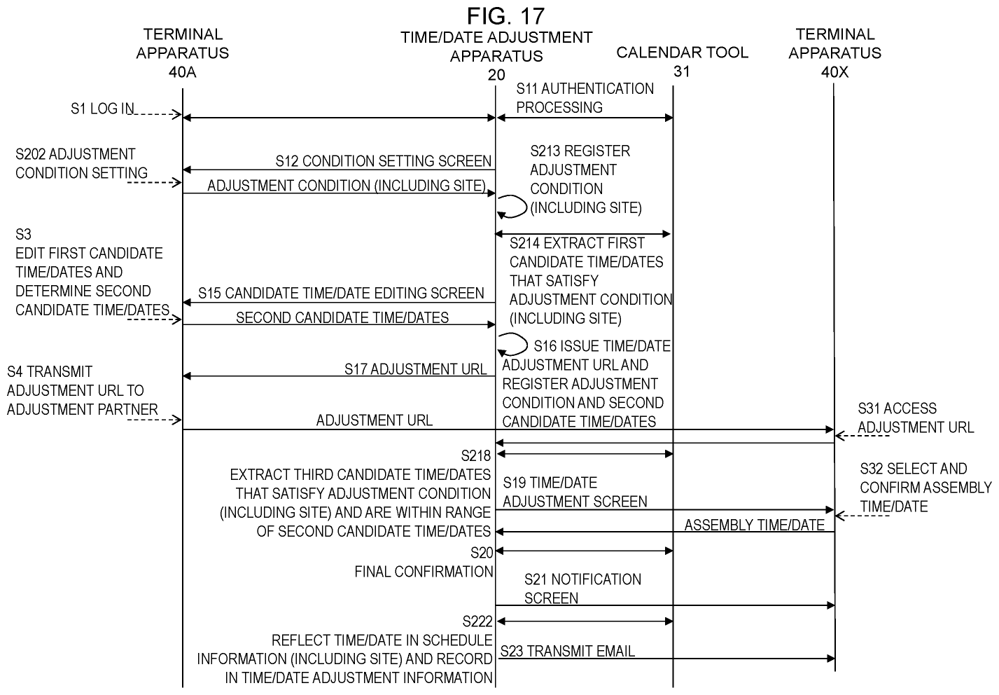

Next, FIG. 17 is a sequence diagram for illustrating a second modification of the time/date adjustment processing performed by the time/date adjustment system 10.

In the second modification, the schedule information 311 of the site of the assembly (meeting room or the like) managed by the calendar tool 31 of the external system 30 is referred to, and the candidate time/dates are extracted with available time/dates of the site being taken into consideration.

In the second modification, Step S2 performed by the terminal apparatus 40A in the time/date adjustment processing illustrated in FIG. 3 is replaced with Step S202, and Steps S13, S14, S18, and S22 performed by the time/date adjustment apparatus 20 are replaced with Steps S213, 5214, 5218, and 5222. Note that operations in common to the second modification and the time/date adjustment processing of FIG. 3 are denoted by the same step numbers, and thus description thereof will be omitted as appropriate.

First of all, the adjustment initiator A logs in to the time/date adjustment apparatus 20, using the terminal apparatus 40A (Step S1), and in response to this, the authentication unit 211 of the time/date adjustment apparatus 20 performs the authentication processing with the external system 30 (Step S11), and the adjustment condition setting unit 212 causes the terminal apparatus 40A to display the condition setting screen 500 (FIG. 4, for example) (Step S12).

Next, the adjustment initiator A inputs and edits each item of the adjustment condition on the condition setting screen 500 displayed in the terminal apparatus 40A, and the adjustment initiator A performs operation on the extract candidate time/date button 520 (Step S202). Note that it is assumed that, in inputting and editing of each item of the adjustment condition in Step S202, the adjustment initiator A designates a meeting room of the company of the adjustment initiator A as the site of the assembly (selection input field 515). Note that, when there are a plurality of meeting rooms (for example, a first meeting room to a third meeting room), one room (for example, the first meeting room) out of the plurality of meeting rooms can be designated, or a plurality of rooms (for example, the first meeting room and the second meeting room) can be designated. Note that all of the rooms of the plurality of meeting rooms may be designated.

Next, in response to the operation performed on the extract candidate time/date button 520, the adjustment condition setting unit 212 of the time/date adjustment apparatus 20 creates new time/date adjustment information 223 in association with the user information 222 of the adjustment initiator A, and registers the set adjustment condition (including designation of the meeting room to be used as the site) (Step S213).

Next, the time/date adjustment unit 213 reads the adjustment condition registered in the time/date adjustment information 223 of the adjustment initiator A from the storage unit 22, refers to the schedule information 311 of the participant and the meeting room managed by the calendar tool 31 of the external system 30, and extracts the first candidate time/dates that are available time/dates of the participant at the current time point and satisfy the adjustment condition (including the designation of the site) (Step S214).

For example, when the first meeting room is designated as the site, the time/date adjustment unit 213 extracts the first candidate time/dates that are available time/dates of the participant at the current time point, are available time/dates of the first meeting room, and satisfy the adjustment condition (except the designation of the site). For example, when the first meeting room and the second meeting room are designated as the site, the time/date adjustment unit 213 extracts the first candidate time/dates that are available time/dates of the participant at the current time point, are available time/dates of at least one of the first and second meeting rooms, and satisfy the adjustment condition (except the designation of the site).

Subsequently, Steps S15, S3, S16, S17, S4, and S31 are executed in order. Next, the time/date adjustment unit 213 of the time/date adjustment apparatus 20 reads the adjustment condition and the second candidate time/dates registered in the time/date adjustment information 223 of the adjustment initiator A from the storage unit 22, refers to the schedule information 311 of the participant and the site managed by the calendar tool 31, and extracts the third candidate time/dates that are available time/dates of the participant at the current time point, satisfy the adjustment condition (including the designation of the site), and are within a range of the second candidate time/dates (Step S218).

Subsequently, Steps S19, S32, S20, and S21 are executed. Next, the time/date adjustment unit 213 of the time/date adjustment apparatus 20 registers the plan of the assembly with the adjustment partner X in the schedule information 311 of the participant managed by the calendar tool 31, similarly to Step S22 described above. The plan of the assembly with the participant and the adjustment partner X are registered in the schedule information 311 of the site managed by the calendar tool 31. Note that, for example, when all of the rooms (first to third meeting rooms) of the meeting rooms are designated as the site and two room, i.e., the first meeting room and the second meeting room, are available in the confirmed assembly time/date, one room, i.e., either the first meeting room or the second meeting room, is selected, and the plan of the assembly with the adjustment partner X is registered in the schedule information 311 of the selected meeting room. Note that, regarding selection of the meeting room, the time/date adjustment unit 213 may perform selection in accordance with a predetermined rule, or the adjustment initiator A may perform selection. Furthermore, the time/date adjustment unit 213 registers the email address of the adjustment partner X, the date and time of the assembly, the site thereof, the place thereof, and the like in the time/date adjustment information 223 corresponding to the adjustment initiator A stored by the storage unit 22 (Step S222). Subsequently, Step S23 is executed, and the second modification of the time/date adjustment processing performed by the time/date adjustment system 10 ends.

According to the second modification of the time/date adjustment processing described above, in addition to effects similar to those of the time/date adjustment processing of FIG. 3, time/date adjustment can be performed which also takes available time/dates of the site of the assembly into consideration.

Typically, for example, the time/date adjustment apparatus of the present embodiment can prepare various operation screens as web pages, and can display such operation screens in a web browser of the terminal apparatus. However, this aspect is not restrictive. For example, a dedicated application including various operation screens may be installed in the terminal apparatus. In this case, by transmitting a part of contents (data such as candidate time/dates) to be displayed on various operation screens to the terminal apparatus, the time/date adjustment apparatus can cause the dedicated application of the terminal apparatus to display various operation screens. In other words, the time/date adjustment apparatus of the present invention may also encompass various aspects in which screens can be displayed in the terminal apparatus.

The present invention is not limited to the embodiments and modifications described above, and further various modifications can be made. For example, the embodiments and the modifications described above are described in detail in order to give simple description of the present invention, and are not necessarily limited to those including all of the configurations described above. A part of one modification may be replaced with another modification, or modifications may be combined together.

A part or all of each configuration, function, processing unit, processing means, and the like described above may be, for example, implemented with hardware by designing those with an integrated circuit, for example. Each configuration, function, and the like described above may be implemented with software by a processor interpreting and executing a program for implementing their respective functions. Information such as a program, a table, and a file for implementing respective functions may be stored in a recording apparatus such as a memory, a hard disk, and an SSD, or a recording medium such as an IC card, an SD card, and a DVD. Illustrated control lines and information lines are those considered to be necessary for the sake of description, and not necessarily all of control lines and information lines for a product are illustrated. It may be considered that most of the configurations are connected to each other in actuality.

### REFERENCE SIGNS LIST

10 . . . Time/date adjustment system
11 . . . Network
20 . . . Time/date adjustment apparatus
21 . . . Processing unit
211 . . . Authentication unit
212 . . . Adjustment condition setting unit
213 . . . Time/date adjustment unit
22 . . . Storage unit
221 . . . Member information
222 . . . User information
223 . . . Time/date adjustment information
23 . . . Communication unit
30 . . . External system
31 . . . Calendar tool
311 . . . Schedule information
40A, 40X . . . Terminal apparatus
500 . . . Condition setting screen
600 . . . Time/date editing screen
700, 800 . . . Time/date adjustment screen
900 . . . Confirmation screen
1000 . . . Notification screen
1100, 1110 . . . Initial value setting screen
1200 . . . Assembly type selection screen

1. A time/date adjustment apparatus comprising:
an adjustment condition setting unit configured to set an adjustment condition related to an assembly; and
a time/date adjustment unit configured to adjust an assembly time/date based on the adjustment condition, wherein
the adjustment condition setting unit causes a first terminal apparatus used by an adjustment initiator to display a condition setting screen for setting the adjustment condition, and sets the adjustment condition including designation of a participant, based on an input of the adjustment initiator on the condition setting screen,
the time/date adjustment unit refers to schedule information of the participant managed by an external system, and extracts available time/dates of the participant satisfying the adjustment condition as first candidate time/dates,
the time/date adjustment unit causes the first terminal apparatus to display a time/date editing screen for editing the extracted first candidate time/dates, and determines second candidate time/dates edited, based on the input of the adjustment initiator on the time/date editing screen and registers the second candidate time/dates in a storage unit,
the time/date adjustment unit issues access information for a time/date adjustment screen,
when a second terminal apparatus used by an adjustment partner performs access based on the access information, the time/date adjustment unit refers to the schedule information of the participant, and extracts third candidate time/dates that are available time/dates of the participant satisfying the adjustment condition and are within a range of the second candidate time/dates registered in the storage unit,
the time/date adjustment unit causes the second terminal apparatus to display the time/date adjustment screen presenting the extracted third candidate time/dates, and determines an assembly time/date out of the third candidate time/dates, based on a selection operation of the adjustment partner on the time/date adjustment screen, and
the time/date adjustment unit registers the determined assembly time/date in the schedule information of the participant managed by the external system.

2. The time/date adjustment apparatus according to claim 1, wherein
the adjustment condition setting unit causes the first terminal apparatus to display a condition initial value setting screen for setting an initial value of the adjustment condition for each type of the assembly, and causes the storage unit to store an adjustment condition initial value set by the adjustment initiator on the condition initial value setting screen, and
the adjustment condition setting unit causes the first terminal apparatus to display the condition setting screen reflecting the adjustment condition initial value stored in the storage unit, based on an operation of the adjustment initiator of selecting the type of the assembly.

3. The time/date adjustment apparatus according to claim 1, wherein
the participant is the adjustment initiator themselves, or a belonging member of an organization to which the adjustment initiator belongs other than the adjustment initiator.

4. The time/date adjustment apparatus according to claim 1, wherein
when a plurality of the participants are designated as the adjustment condition,
the time/date adjustment unit refers to the schedule information of all of the plurality of the participants managed by the external system, and extracts the available time/dates common to all of the plurality of the participants satisfying the adjustment condition as the first candidate time/dates, and
when the second terminal apparatus used by the adjustment partner performs access based on the access information, the time/date adjustment unit refers to the schedule information of all of the plurality of the participants, and extracts the third candidate time/dates that are the available time/dates common to all of the plurality of the participants satisfying the adjustment condition and are within the range of the second candidate time/dates registered in the storage unit.

5. The time/date adjustment apparatus according to claim 1, wherein
when a plurality of the participants are designated as the adjustment condition,
the time/date adjustment unit refers to the schedule information of all of the plurality of the participants managed by the external system, and extracts the available time/dates of at least one of all of the plurality of the participants satisfying the adjustment condition as the first candidate time/dates, and
when the second terminal apparatus used by the adjustment partner performs access based on the access information, the time/date adjustment unit refers to the schedule information of all of the plurality of the participants, and extracts the third candidate time/dates that are the available time/dates of at least one of all of the plurality of the participants satisfying the adjustment condition and are within the range of the second candidate time/dates registered in the storage unit.

6. The time/date adjustment apparatus according to claim 1, wherein
the adjustment condition includes information for designating a site to be used for the assembly,
the time/date adjustment unit refers to schedule information of the designated site in addition to the schedule information of the participant managed by the external system, and extracts the available time/dates of both of the participant and the site satisfying the adjustment condition as the first candidate time/dates, and
when the second terminal apparatus performs access based on the access information, the time/date adjustment unit refers to the schedule information of the participant and the site, and extracts the third candidate time/dates that are the available time/dates of both of the participant and the site satisfying the adjustment condition and are within the range of the second candidate time/dates registered in the storage unit.

7. The time/date adjustment apparatus according to claim 1, wherein
the adjustment condition includes information for designating a plurality of sites that is allowed to be used for the assembly,
the time/date adjustment unit refers to schedule information of the plurality of designated sites in addition to the schedule information of the participant managed by the external system, and extracts the available time/dates of both of the participant and one of the plurality of designated sites satisfying the adjustment condition as the first candidate time/dates, and
when the second terminal apparatus performs access based on the access information, the time/date adjustment unit refers to the schedule information of the participant and the plurality of sites, and extracts the third candidate time/dates that are the available time/dates of both of the participant and one of the plurality of designated sites satisfying the adjustment condition and are within the range of the second candidate time/dates registered in the storage unit.

8. The time/date adjustment apparatus according to claim 1, wherein
the adjustment condition setting unit receives designation of a place of the assembly, based on the input of the adjustment initiator on the condition setting screen, and
the time/date adjustment unit causes the second terminal apparatus performing access based on the access information to display the time/date adjustment screen displaying the place of the assembly designated by the adjustment initiator.

9. The time/date adjustment apparatus according to claim 8, wherein
on the time/date adjustment screen displayed in the second terminal apparatus, the adjustment partner is allowed to change the place of the assembly designated by the adjustment initiator, and
the time/date adjustment unit causes results of the change of the place of the assembly by the adjustment partner to reflect in the schedule information of the participant managed by the external system.

10. The time/date adjustment apparatus according to claim 1, wherein
the adjustment condition setting unit receives designation of a method of the assembly, based on the input of the adjustment initiator on the condition setting screen, and
the time/date adjustment unit causes the second terminal apparatus performing access based on the access information to display the time/date adjustment screen displaying the method of the assembly designated by the adjustment initiator.

11. The time/date adjustment apparatus according to claim 10, wherein
on the time/date adjustment screen displayed in the second terminal apparatus, the adjustment partner is allowed to change the method of the assembly designated by the adjustment initiator, and
the time/date adjustment unit causes results of the change of the method of the assembly by the adjustment partner to reflect in the schedule information of the participant managed by the external system.

12. The time/date adjustment apparatus according to claim 1, further comprising
an authentication unit configured to perform authentication processing of the adjustment initiator with the external system, wherein
the time/date adjustment unit refers to the schedule information of the participant being a belonging member of an organization to which the adjustment initiator belongs, the schedule information requiring authentication, the schedule information being managed by the external system.

13. The time/date adjustment apparatus according to claim 1, wherein
the adjustment condition includes information for designating time required for the assembly, a time frame in which the assembly is capable of being held, and information for designating an extraction span, and
the time/date adjustment unit extracts a time/date in which the time required is capable of being secured in the time frame in which the assembly is capable of being held out of the available time/dates of the participant in the extraction span.

14. The time/date adjustment apparatus according to claim 13, wherein
the adjustment condition includes information for designating time secured before and after the assembly, and
the time/date adjustment unit extracts a time/date in which the time required is capable of being secured in the time frame in which the assembly is capable of being held and the time/date in which the time secured before and after is capable of being secured out of the available time/dates of the participant in the extraction span.

15. The time/date adjustment apparatus according to claim 1, wherein
the time/date adjustment unit causes the first terminal apparatus to display the time/date editing screen presenting the extracted first candidate time/dates and an existing plan of the participant.

16. A time/date adjustment method performed by a time/date adjustment apparatus, the time/date adjustment method comprising:
an adjustment condition setting step of setting an adjustment condition related to an assembly; and
a time/date adjustment step of adjusting an assembly time/date based on the adjustment condition, wherein
the adjustment condition setting step includes causing a first terminal apparatus used by an adjustment initiator to display a condition setting screen for setting the adjustment condition, and setting the adjustment condition including designation of a participant, based on an input of the adjustment initiator on the condition setting screen,
the time/date adjustment step includes referring to schedule information of the participant managed by an external system, and extracting available time/dates of the participant satisfying the adjustment condition as first candidate time/dates,
the time/date adjustment step includes causing the first terminal apparatus to display a time/date editing screen for editing the extracted first candidate time/dates, and determining second candidate time/dates edited, based on the input of the adjustment initiator on the time/date editing screen and registering the second candidate time/dates in a storage unit,
the time/date adjustment step includes issuing access information for a time/date adjustment screen,
when a second terminal apparatus used by an adjustment partner performs access based on the access information, the time/date adjustment step includes referring to the schedule information of the participant, and extracting third candidate time/dates that are available time/dates of the participant satisfying the adjustment condition and are within a range of the second candidate time/dates registered in the storage unit,
the time/date adjustment step includes causing the second terminal apparatus to display the time/date adjustment screen presenting the extracted third candidate time/dates, and determining an assembly time/date out of the third candidate time/dates, based on a selection operation of the adjustment partner on the time/date adjustment screen, and
the time/date adjustment step includes registering the determined assembly time/date in the schedule information of the participant managed by the external system.

17. A non-transitory computer-readable storage medium storing a program causing a computer to function as:
an adjustment condition setting unit configured to set an adjustment condition related to an assembly; and
a time/date adjustment unit configured to adjust an assembly time/date based on the adjustment condition, wherein
the adjustment condition setting unit causes a first terminal apparatus used by an adjustment initiator to display a condition setting screen for setting the adjustment condition, and sets the adjustment condition including designation of a participant, based on an input of the adjustment initiator on the condition setting screen,
the time/date adjustment unit refers to schedule information of the participant managed by an external system, and extracts available time/dates of the participant satisfying the adjustment condition as first candidate time/dates,
the time/date adjustment unit causes the first terminal apparatus to display a time/date editing screen for editing the extracted first candidate time/dates, and determines second candidate time/dates edited, based on the input of the adjustment initiator on the time/date editing screen and registers the second candidate time/dates in a storage unit,
the time/date adjustment unit issues access information for a time/date adjustment screen,
when a second terminal apparatus used by an adjustment partner performs access based on the access information, the time/date adjustment unit refers to the schedule information of the participant, and extracts third candidate time/dates that are available time/dates of the participant satisfying the adjustment condition and are within a range of the second candidate time/dates registered in the storage unit,
the time/date adjustment unit causes the second terminal apparatus to display the time/date adjustment screen presenting the extracted third candidate time/dates, and determines an assembly time/date out of the third candidate time/dates, based on a selection operation of the adjustment partner on the time/date adjustment screen, and
the time/date adjustment unit registers the determined assembly time/date in the schedule information of the participant managed by the external system.
